(19) United States
(12) Patent Application Publication
(10) Pub. No.: US 2026/0291706 A1
(43) Pub. Date: Sep. 24, 2026

(54) ENHANCED CSI REPORTING FOR SBFD CAPABLE UE

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Ahmed Attia ABOTABL, San Diego, CA (US)

(21) Appl. No.: 19/087,275

(22) Filed: Mar. 21, 2025

(51) Int. Cl. H04L 5/14; H04L 5/00; H04W 72/232; H04W 72/541

(52) U.S. Cl. CPC H04L 5/1461; H04L 5/0048; H04W 72/232; H04W 72/541

(57) ABSTRACT

A method for wireless communication at a user equipment (UE) and related apparatus are provided. In the method, the UE receives, from a network entity, a configuration for an uplink transmission resource and a set of measurement resources overlapping in time with the uplink transmission resource. The UE performs a self-interference (SI) measurement based on one or more uplink transmission power hypotheses for the SI measurement. The one or more uplink transmission power hypotheses for the SI measurement respectively correspond to the set of measurement resources. The UE then transmits to the network entity a channel state information (CSI) report including one or more CSI metrics based on the SI measurement.

### TECHNICAL FIELD

The present disclosure relates generally to communication systems and, more particularly, to channel state information (CSI) reporting in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to receive, from a network entity, a configuration for an uplink transmission resource and a set of measurement resources overlapping in time with the uplink transmission resource; perform an SI measurement based on one or more uplink transmission power hypotheses for the SI measurement, where the one or more uplink transmission power hypotheses for the SI measurement respectively correspond to the set of measurement resources; and transmit, to the network entity, a CSI report including one or more CSI metrics based on the SI measurement.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to transmit, to a UE, a configuration for an uplink transmission resource and a set of measurement resources overlapping in time with the uplink transmission resource; and receive, from the UE, a CSI report including one or more CSI metrics, where the one or more CSI metrics are based on an SI measurement based on one or more uplink transmission power hypotheses, where the one or more uplink transmission power hypotheses for the SI measurement respectively correspond to the set of measurement resources.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A, FIG. 4B, FIG. 4C, and FIG. 4D illustrate various modes of full duplex communication.

FIG. 5 illustrates examples of in-band full-duplex (IBFD) and subband frequency divisional duplex resources.

FIG. 6 is a diagram illustrating an example of subband full-duplex (SBFD) operation.

FIG. 7A is a diagram illustrating an example of a UE's operation mode selection based on the level of self-interference (SI) experienced by the UE.

FIG. 7B is a diagram illustrating an example of computing the maximum transmit power for a UE considering the residual SI.

FIG. 8 is a diagram illustrating example associations between a channel state information (CSI) report and various measurement resources.

FIG. 9 is a diagram illustrating example associations between a CSI report and various measurement resource configurations.

FIG. 10 is a diagram illustrating example associations between a CSI report and SI measurement resources in accordance with various aspects of the present disclosure.

FIG. 11 is a diagram illustrating an example of residual SI measurement in accordance with various aspects of the present disclosure.

FIG. 12 is a diagram illustrating an example of a one-to-one correspondence between the SI measurement resources and channel state information-reference signal (CSI-RS) resources in accordance with various aspects of the present disclosure.

FIG. 13A is a diagram illustrating multiple symbols configured for a measurement occasion in accordance with various aspects of the present disclosure.

FIG. 13B is a diagram illustrating multiple measurement occasions configured for a measurement resource in accordance with various aspects of the present disclosure.

FIG. 14A is a diagram illustrating multiple SI measurement resources configured within the same set in accordance with various aspects of the present disclosure.

FIG. 14B is a diagram illustrating example SI measurement resources relative to uplink transmissions with uplink transmit power hypotheses in accordance with various aspects of the present disclosure.

FIG. 15 is a call flow diagram illustrating a method of wireless communication in accordance with various aspects of the present disclosure.

FIG. 16 is a flowchart illustrating methods of wireless communication at a UE in accordance with various aspects of the present disclosure.

FIG. 17 is a flowchart illustrating methods of wireless communication at a UE in accordance with various aspects of the present disclosure.

FIG. 18 is a flowchart illustrating methods of wireless communication at a network entity in accordance with various aspects of the present disclosure.

FIG. 19 is a diagram illustrating an example of a hardware implementation for an example apparatus and/or UE.

FIG. 20 is a diagram illustrating an example of a hardware implementation for an example network entity.

### DETAILED DESCRIPTION

In wireless communication, a receiver can transmit a channel state information (CSI) report that provides information about the properties of the communication channel between the transmitter and the receiver, which may be used to improve communication performance. The receiver may evaluate the CSI of the channel through measurement of a reference signal (RS), such as a channel state information-reference signal (CSI-RS) or synchronization signal block (SSB) transmitted from a transmitter over the communication channel. A subband full duplex (SBFD) aware user equipment (UE) may operate in an SBFD environment, enabling simultaneous transmission and reception on respectively subbands. However, the coexistence of uplink and downlink signals may cause self-interference (SI) on the UE. Existing CSI reporting mechanisms may not adequately capture the impact of SI, particularly under different uplink transmit power hypotheses, which may influence the levels of residual SI. Example aspects presented herein provide methods and apparatus to enhance CSI report to reflect varying levels of residual SI based on multiple uplink transmit power hypotheses.

Various aspects relate generally to wireless communication. Some aspects more specifically relate to enhanced CSI reporting for UE that is capable of performing SBFD operations. In some examples, a UE receives from a network entity a configuration for an uplink transmission resource and a set of measurement resources overlapping in time with the uplink transmission resource. The UE then performs an SI measurement based on one or more uplink transmission power hypotheses for the SI measurement. The one or more uplink transmission power hypotheses for the SI measurement respectively may correspond to the set of measurement resources. The UE transmits to the network entity a CSI report including one or more CSI metrics based on the SI measurement. In some examples, the one or more uplink transmission power hypotheses may include multiple uplink transmission power hypotheses, and the UE may receive from the network entity a CSI report configuration for the CSI report or a semi-persistent or periodic (SP/P) uplink transmission configuration for an uplink signal. The CSI report configuration or the SP/P uplink transmission configuration may indicate the multiple uplink transmission power hypotheses. In some aspects, the one or more uplink transmission power hypotheses may include multiple uplink transmission power hypotheses. In some aspects, the CSI report may include multiple CSI metrics respectively corresponding to the multiple uplink transmission power hypotheses. In some aspects, the CSI report may include one CSI metric based on one uplink transmission power hypothesis of the multiple uplink transmission power hypotheses.

Particular aspects of the subject matter described in this disclosure can be implemented to realize one or more of the following potential advantages. In some examples, by incorporating the impact of SI into CSI metrics, the described techniques enable more accurate and efficient CSI reporting for SBFD capable UE. In some examples, by enhancing CSI reporting to account for SI under multiple uplink transmit power hypotheses, the described techniques enable the network to better adapt to varying SI conditions at the UE, thereby allowing for more accurate scheduling and resource allocation.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

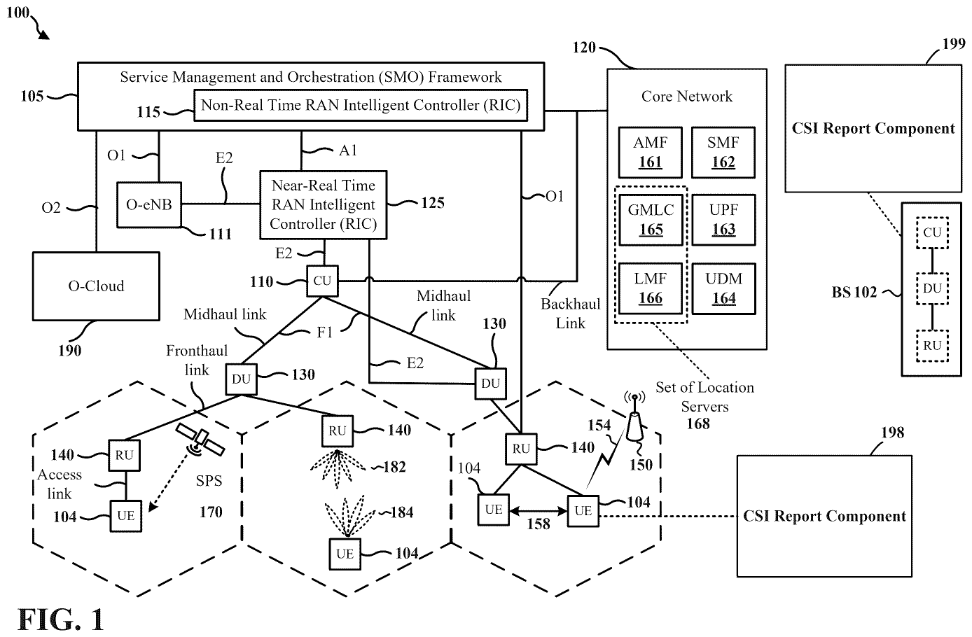

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the CSI report component 198. The CSI report component 198 may be configured to receive, from a network entity, a configuration for an uplink transmission resource and a set of measurement resources overlapping in time with the uplink transmission resource; perform an SI measurement based on one or more uplink transmission power hypotheses for the SI measurement, where the one or more uplink transmission power hypotheses for the SI measurement respectively correspond to the set of measurement resources; and transmit, to the network entity, a CSI report including one or more CSI metrics based on the SI measurement. In certain aspects, the base station 102 may include the CSI report component 199. The CSI report component 199 may be configured to transmitting, to a UE, a configuration for an uplink transmission resource and a set of measurement resources overlapping in time with the uplink transmission resource; and receive, from the UE, a CSI report including one or more CSI metrics. The one or more CSI metrics may be based on an SI measurement based on one or more uplink transmission power hypotheses. The one or more uplink transmission power hypotheses for the SI measurement may respectively correspond to the set of measurement resources. Although the following description may be focused on 5G NR, the concepts described herein may be applicable to other similar areas, such as LTE, LTE-A, CDMA, GSM, and other wireless technologies.

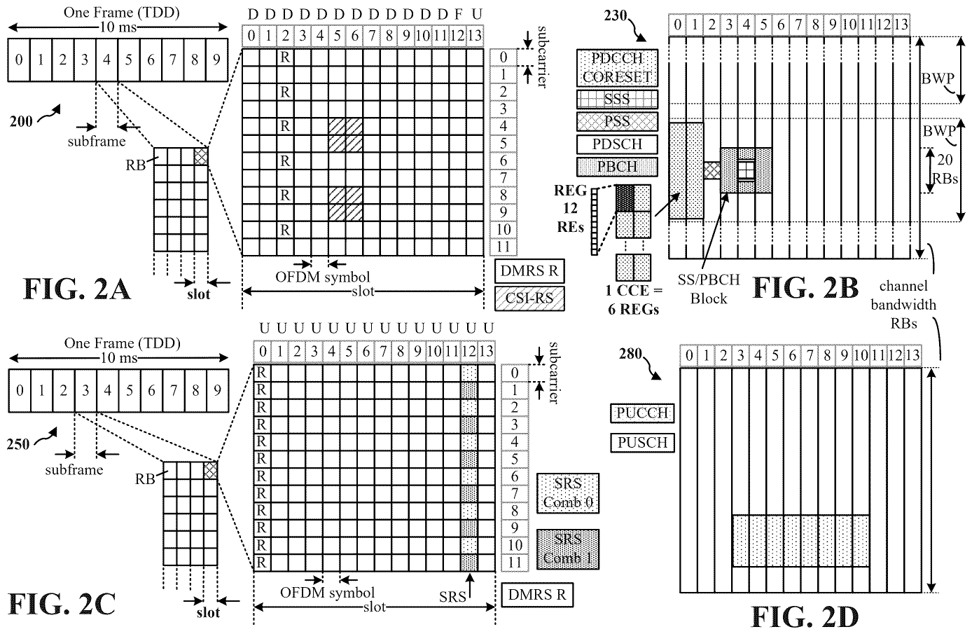

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

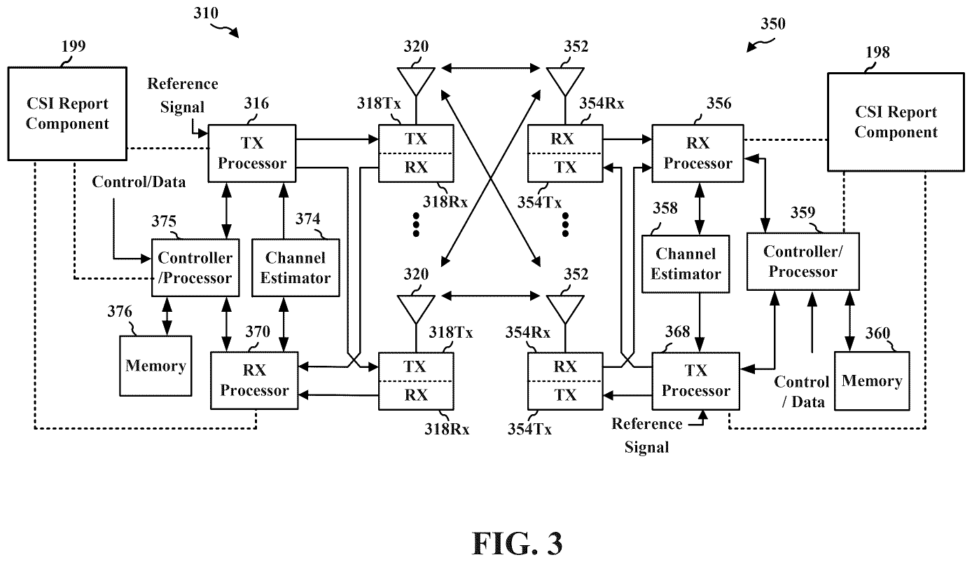

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CSI report component 198 of FIG. 1.

At least one of the TX processor 316, the RX processor 370, and the controller/processor 375 may be configured to perform aspects in connection with the CSI report component 199 of FIG. 1.

Wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time may enable more efficient use of the wireless spectrum. Full duplex operation may include simultaneous transmission and reception in the same frequency range. In some examples, the frequency range may be a millimeter wave (mmW) frequency range, e.g., frequency range 2 (FR2). In some examples, the frequency range may be a sub-6 GHz frequency range, e.g., frequency range 1 (FR1). Full duplex communication may reduce latency. For example, full duplex operation may enable a UE to receive a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

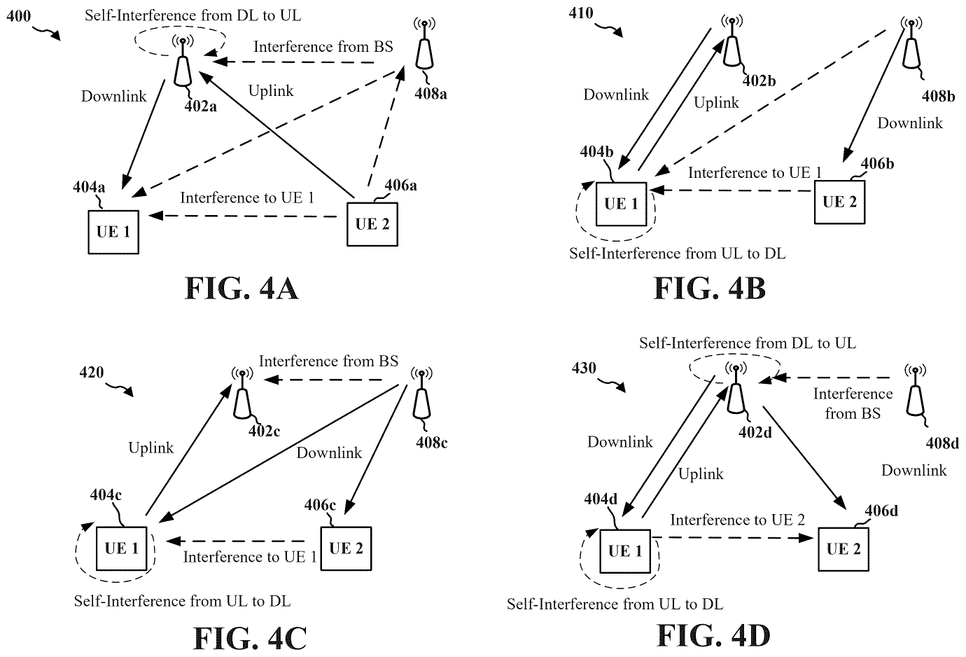

FIG. 4A, FIG. 4B, FIG. 4C, and FIG. 4D illustrate various modes of full duplex communication. Full duplex communication supports transmission and reception of information over the same frequency band in a manner that overlaps in time. In this manner, spectral efficiency may be improved with respect to the spectral efficiency of half-duplex communication, which supports transmission or reception of information in one direction at a time without overlapping uplink and downlink communication. Due to the simultaneous Tx/Rx nature of full duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication, or even lead to a loss of information.

FIG. 4A shows a first example of full duplex communication 400 in which a first base station 402a is in full duplex communication with a first UE 404a and a second UE 406a. The first UE 404a and the second UE 406a may be configured for half-duplex communication or full-duplex communication. FIG. 4A illustrates the first UE 404a performing downlink reception, and the second UE 406a performing uplink transmission. The second UE 406a may transmit a first uplink signal to the first base station 402a as well as to other base stations, such as a second base station 408a in proximity to the second UE 406a. The first base station 402a transmits a downlink signal to the first UE 404a concurrently (e.g., overlapping at least partially in time) with receiving the uplink signal from the second UE 406a. The base station 402a may experience self-interference at its receiving antenna that is receiving the uplink signal from UE 406a, the self-interference being due to reception of at least part of the downlink signal transmitted to the UE 404a. The base station 402a may experience additional interference due to signals from the second base station 408a. Interference may also occur at the first UE 404a based on signals from the second base station 408a as well as from uplink signals from the second UE 406a.

FIG. 4B shows a second example of full-duplex communication 410 in which a first base station 402b is in full-duplex communication with a first UE 404b. In this example, the UE 404b is also operating in a full-duplex mode. The first base station 402b and the UE 404b receive and transmit communication that overlaps in time and is in the same frequency band. The base station and the UE may each experience self-interference, due to a transmitted signal from the device leaking to (e.g., being received by) a receiver at the same device. The first UE 404b may experience additional interference based on one or more signals emitted from a second UE 406b and/or a second base station 408b in proximity to the first UE 404b.

FIG. 4C shows a third example of full-duplex communication 420 in which a first UE 404c transmits and receives full-duplex communication with a first base station 402c and a second base station 408c. The first base station 402c and the second base station 408c may serve as multiple transmission and reception points (multi-TRPs) for UL and DL communication with the UE 404c. The second base station 408c may also exchange communication with a second UE 406c. In FIG. 4C, the first UE 404c may transmit an uplink signal to the first base station 402c that overlaps in time with receiving a downlink signal from the second base station 408c. The first UE 404c may experience self-interference as a result of receiving at least a portion of the first signal when receiving the second signal, e.g., the UE's uplink signal to the base station 402c may leak to (e.g., be received by) the UE's receiver when the UE is attempting to receive the signal from the other base station 408c. The first UE 404c may experience additional interference from the second UE 406c.

FIG. 4D shows a fourth example of full-duplex communication 430 in which a first base station 402d employs full-duplex communication with a first UE 404d, and transmits downlink communication to a second UE 406d. In this example, the first UE 404d is operating in a full-duplex mode, and the second UE 406d is operating in a half-duplex mode. The first base station 402d and the first UE 404d receive and transmit communication that overlaps in time and is in the same frequency band. The base station 402d and the first UE 404d may each experience self-interference, due to a transmitted signal from the corresponding device leaking to (e.g., being received by) a receiver at the same device. The base station 402d may further experience cross link interference due to a signal transmitted by the base station 408d. The second UE 406d may experience cross-link interference from the uplink transmission of the first UE 404b when receiving downlink communication from the base station 402d.

There may be various modes of full duplex communication. Full duplex communication supports the transmission and reception of information over the same frequency band in a manner that overlaps in time. In this manner, spectral efficiency may be improved with respect to the spectral efficiency of half-duplex communication, which supports the transmission or reception of information in one direction at a time without overlapping uplink and downlink communication

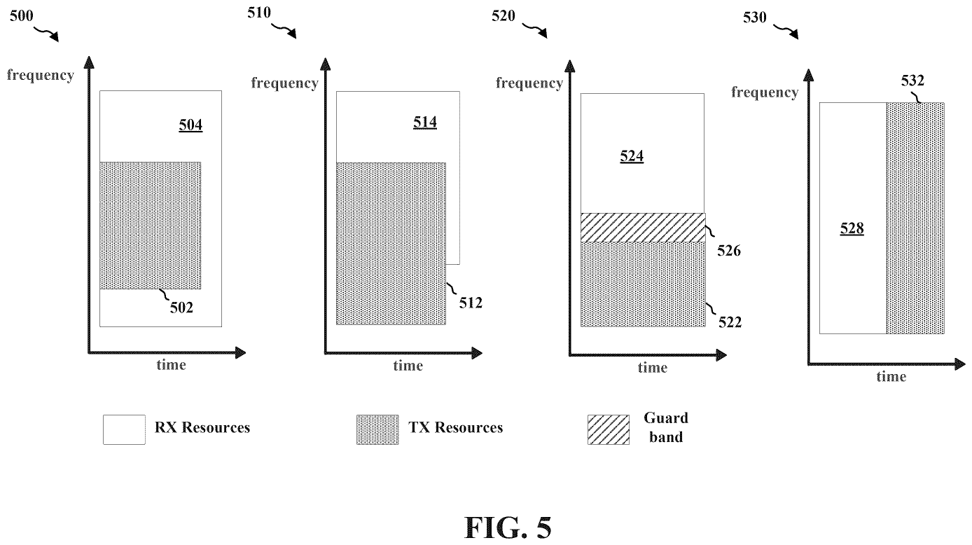

In some aspects, a first base station may transmit and receive full duplex communication with a first UE and a second UE that transmit or receive half-duplex communication in a half-duplex mode. In some aspects, a base station may transmit and receive full-duplex communication with a UE that operates in a full-duplex mode. Full duplex communication may be in the same frequency band. The uplink and downlink communication may be in different frequency subbands, in the same frequency subband, or in partially overlapping frequency subbands. FIG. 5 illustrates a first example 500 and a second example 510 of in-band full-duplex (IBFD) resources and a third example 520 of SBFD resources. In IBFD, signals may be transmitted and received in overlapping times and overlapping in frequency. As shown in the first example 500, a time and a frequency allocation of transmission resources 502 may fully overlap with a time and a frequency allocation of reception resources 504. In the second example 510, a time and a frequency allocation of transmission resources 512 may partially overlap with a time and a frequency of allocation of reception resources 514.

IBFD is in contrast to subband FDD, where transmission and reception resources may overlap in time using different frequencies, as shown in the third example 520. In the third example 520, the UL, the transmission resources 522 are separated from the reception resources 524 by a guard band 526. The guard band may be frequency resources, or a gap in frequency resources, provided between the transmission resources 522 and the reception resources 524. Separating the transmission frequency resources and the reception frequency resources with a guard band may help to reduce self-interference. Transmission resources and reception resources that are immediately adjacent to each other may be considered as having a guard band width of 0. As an output signal from a wireless device may extend outside the transmission resources, the guard band may reduce interference experienced by the wireless device. Subband FDD may also be referred to as “flexible duplex.”

A fourth example 530 illustrates an example of half-duplex resources in which the reception resources 528 do not overlap in time with the transmission resources 532.

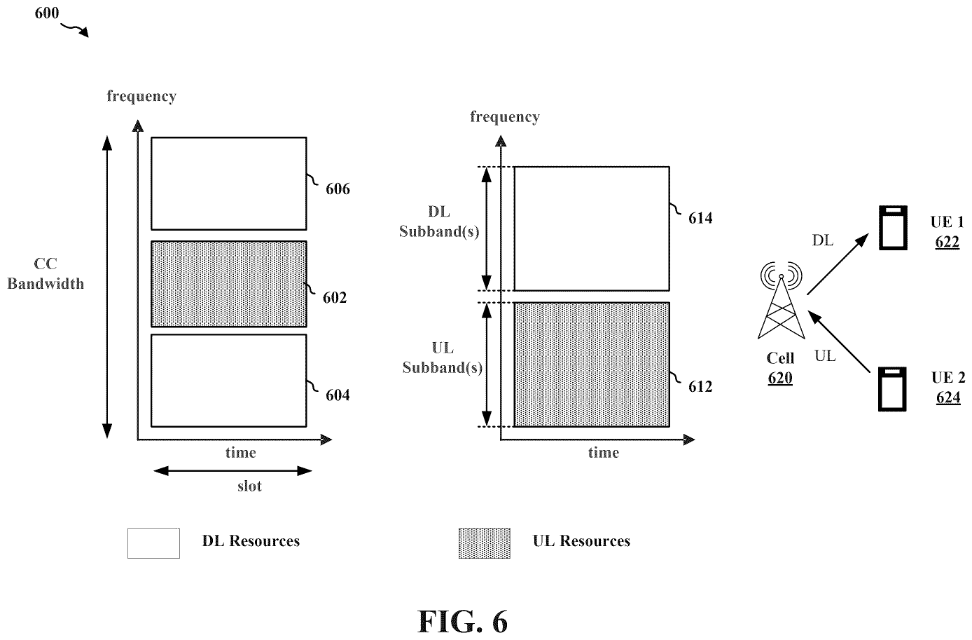

FIG. 6 is a diagram 600 illustrating an example of SBFD operation. As shown in FIG. 6, a cell 620 may have DL communication with one UE (e.g., UE 1 622), and simultaneously have UL communication with another UE (e.g., UE 2 624) on the same slot. In one example, the DL communication with UE 1 622 may utilize DL resources 604, 606, and the UL communication with UE 2 624 may utilize UL resources 602. In another example, the DL communication with UE 1 622 may utilize DL resources 614, and the UL communication with UE 2 624 may utilize UL resources 612.

In wireless communication, some UE may have limited SI mitigation capability, which is represented by the parameter alpha (α). For example, the residual SI per resource block (per-RB), denoted as

$${I}_{S I}^{per - RB} ,$$

may be expressed as:

$${I}_{S I}^{per - RB} = \frac{{p}_{t x}^{p e r - R B}}{{α}_{SI}} \qquad ( 1 )$$

where

$${p}_{t x}^{per - RB}$$

denotes the transmit power per resource block and α_{SI} represents the SI mitigation capability of the UE.

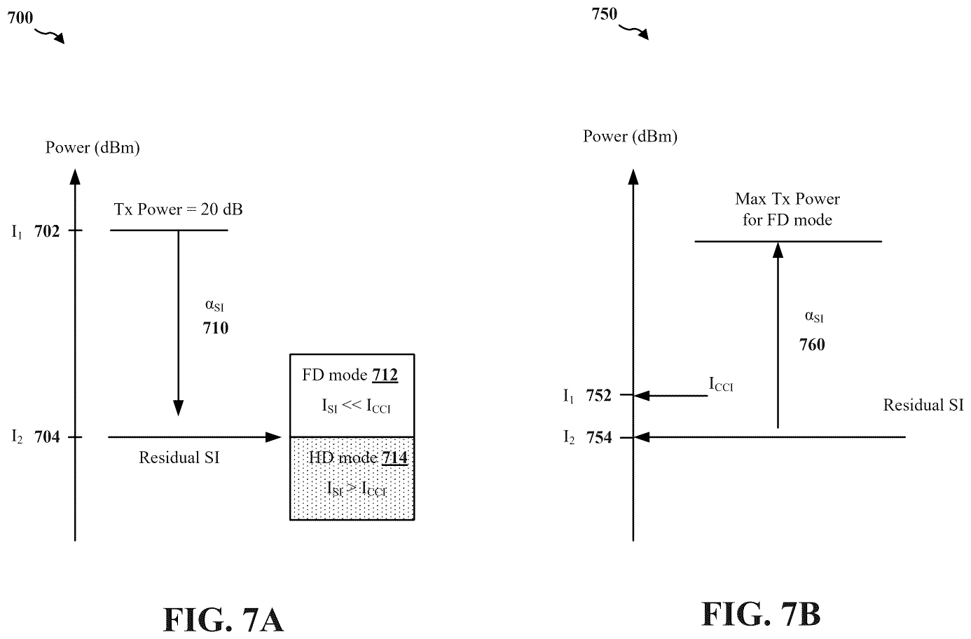

As shown in Equation (1), the impact of this residual SI depends on the overall desense (e.g., a reduction in a receiver's sensitivity caused by interference). The two main factors that determine the level of residual SI include the transmit power and the level of interference from other sources, such as inter-cell interference level, compared to the residual desense. A UE's operation model (e.g., full duplex (FD) or half duplex (HD)) may be determined by the dominant source of interference. FIG. 7A is a diagram 700 illustrating an example of a UE's operation mode selection based on the level of SI experienced by the UE. As shown in FIG. 7A, for a maximum transmit power of 20 dB, the corresponding SI level may be denoted as I₁ 702. After applying the interference mitigation (or cancellation) measure α_{SI} 710, the SI may be reduced to a residual SI I₂ 704. The UE's operation mode (e.g., FD or HD) may be determined based on the comparison between the residual SI I₂ 714 and other types of interference, such as co-channel interference I_{CCI}. For example, if the co-channel interference is a dominant source of interference compared to the residual SI I₂ 704 (i.e., I_{SI}<<I_{CCI}), the UE may operate in FD mode 712. On the other hand, if the residual SI I₂ 704 is comparable to, or even greater than, the co-channel interference (e.g., I_{SI}>I_{CCI}), then the UE may operate in HD mode 714 to reduce the impact of interference.

FIG. 7B is a diagram 750 illustrating an example of computing the maximum transmit power for a UE considering the residual SI. As shown in FIG. 7B, to calculate the maximum transmit power for a UE, the interference from other sources (excluding SI), such as the co-channel interference I₁ 752 may first be identified. Based on this interference level I₁ 752, a corresponding residual SI I₂ 754 may be computed or measured such that it meets a target desense threshold (e.g., a 1 dB desense). Then, based on the computed or measured residual SI I₂ 754, the maximum transmit power for FD operation may be determined by considering the applied interference mitigation (or cancellation) measure α_{SI} 760.

In wireless communication, a receiver can transmit a CSI report that provides information about the properties of the communication channel between the transmitter and the receiver, which may be used to improve communication, e.g., through improved scheduling or adjustment of characteristics of a wireless transmission, such as a modulation, code rate, or beamforming, among other examples. The receiver may evaluate the CSI of the channel through measurement of a reference signal (RS) (e.g., CSI-RS or synchronization signal block (SSB)) transmitted from a transmitter over the communication channel. Among other information, a CSI report may indicate one or more of a channel quality indicator (CQI), precoding matrix indicator (PMI), CSI-RS resource indicator (CRI), SS/PBCH block resource indicator (SSBRI), layer indicator (LI), rank indicator (RI), layer 1 (L1)-reference signal received power (L1-RSRP), layer 1-signal-to-interference-plus-noise ratio (L1-SINR) or capability index, for example. The UE (e.g., as an example of a receiver) may be configured with one or more CSI-RS resource sets, and each CSI-RS resource set may include, or indicate, one or more configured CSI-RS. The CSI report configuration that the UE receives may indicate one or more CSI-RS resource sets to be measured for a CSI report.

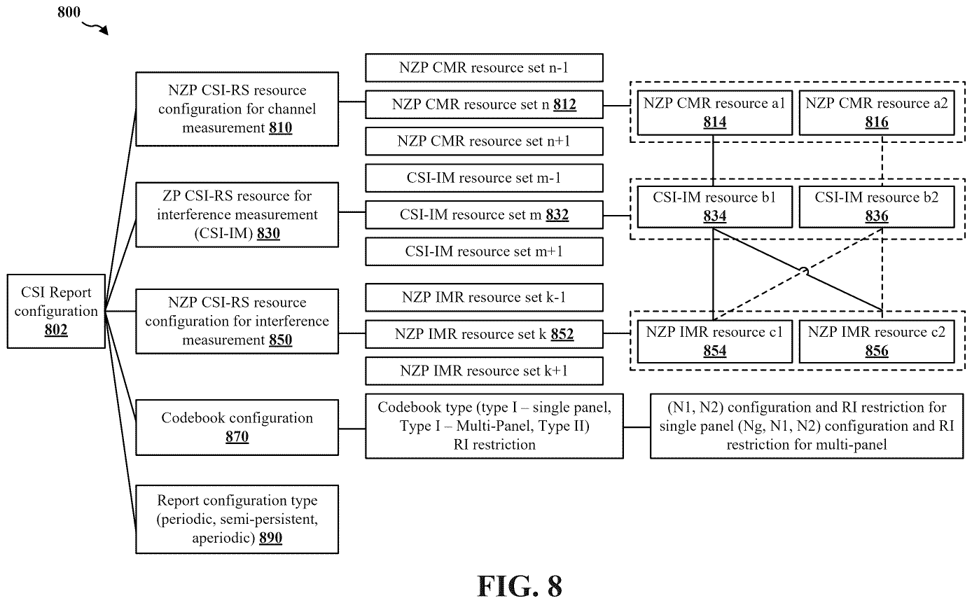

FIG. 8 is a diagram 800 illustrating example associations between a CSI report and various measurement resources. As shown in FIG. 8, a UE may receive a configuration for a reference signal (such as a CSI-RS) to be measured, and a configuration for a CSI report (e.g., CSI report configuration 802) to be provided to the transmitter (e.g., which may be a network entity such as a base station or one or more components of a base station). The CSI report configuration (e.g., CSI report configuration 802) may be associated with various resources or resource configurations for measurements, including the non-zero power (NZP) CSI-RS resource configuration for channel measurement 810, zero power (ZP) CSI-RS resources for interference measurement (CSI-IM) 830, and NZP CSI-RS resource configuration for interference measurement 850.

Each of these resources or resource configurations may be associated with one or more resource sets, and each of these resource sets may include one or more resources. For example, NZP CSI-RS resource configuration for channel measurement 810 may be associated with NZP CMR resource set n 812, which may include NZP CMR resource a1 814 and NZP CMR resource a2 816. ZP CSI-IM 830 may be associated with CSI-IM resource set m 832, which may include CSI-IM resource b1 834 and CSI-IM resource b2 836. NZP CSI-RS resource configuration for interference measurement 850 may be associated with NZP IMR resource set k 852, which may include NZP IMR resource c1 854 and NZP IMR resource c2 856.

As shown in FIG. 8, in some examples, the NZP CMR resource (e.g., NZP CMR resource a1 814 and NZP CMR resource a2 816) may have a one-to-one correspondence with the CSI-IM resource (e.g., CSI-IM resource b1 834 and CSI-IM resource b2 836). In some examples, the CSI-IM resource (e.g., CSI-IM resource b1 834 and CSI-IM resource b2 836) may have a one-to-many correspondence with the NZP IMR resource (e.g., NZP IMR resource c1 854 and NZP IMR resource c2 856).

In some examples, the CSI report configuration (e.g., CSI report configuration 802) may be further associated with other CSI related configurations, such as codebook configuration 870 and reporting configuration type 890.

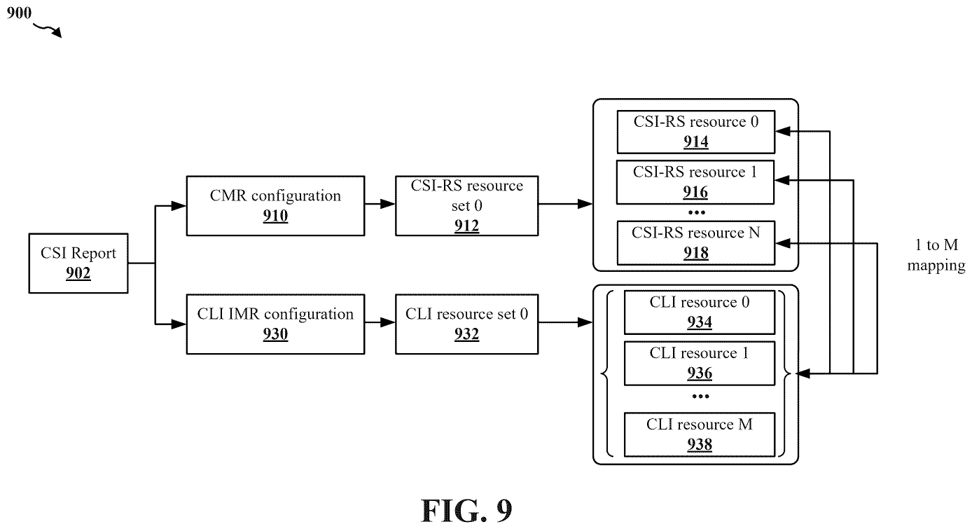

In some examples, a CSI report may be associated with one or more interference measurement resources for interference reporting, such as implicit cross-link interference (CLI) reporting. FIG. 9 is a diagram 900 illustrating example associations between a CSI report and various measurement resource configurations. As shown in FIG. 9, a CSI report 902 may be associated with a CLI IMR configuration 930, which may be associated with the CLI resource set 0 932. The CLI resource set 0 932 may include one or more CLI resources (e.g., CLI resource 0 934, CLI resource 1 936, through CLI resource M 938). The CSI report 902 may also be associated with a channel measurement resource (CMR) configuration 910, which may be associated with the CSI-RS resource set 0 912. The CSI-RS resource set 0 912 may include one or more CSI-RS resources (e.g., CSI-RS resource 0 914, CSI-RS resource 1 916, through CSI-RS resource N 918).

In some examples, there may have a one-to-many mapping between the CLI resources (e.g., CLI resource 0 934, CLI resource 1 936 through CLI resource m 938) and the CMR resources (e.g., CSI-RS resource 0 914, CSI-RS resource 1 916 through CSI-RS resource N 918). In some examples, the CSI metric then may be updated based on the CLI interference measurement resources (CLI resource 0 934, CLI resource 1 936 through CLI resource M 938).

Similar to the CLI reporting, such as the CLI reporting based on the CLI IMR configuration 930, the impact of SI may be reported to the network for SBFD-capable UE. In some aspects, SBFD-capable UEs may provide explicit reporting of SI to the network, which may be based on the CLI framework (e.g., based on the CLI IMR configuration 930). For example, this may involve received signal strength indicator (RSSI) reporting that captures both SI and CLI.

In some aspects, SBFD-capable UEs may provide implicit reporting for SI by enhancing the CSI framework so that the reported CSI metrics reflect the impact of residual SI. In this case, the UE may report parameters such as rank and modulation and coding scheme (MCS), considering the presence of residual SI. Example aspects presented herein provide methods and apparatus to enhance the CSI report with different levels of residual SI based on multiple uplink (UL) transmit (Tx) power hypotheses. Several aspects to be considered for enabling implicit SI reporting may include simultaneous uplink transmission with the measurement resources at the UE, the determination of the uplink transmit power hypothesis, as the uplink transmit power will affect the reported CSI metrics, and the possibility of including CSI metrics related to multiple power hypotheses in the CSI report. Additionally, configuration aspects related to measurement resources and CSI reporting are also provided to enable the measurement resource allocation and CSI reporting that reflects the residual SI.

In some aspects, an additional interference measurement resource (IMR) may be defined for SI measurement or combined CLI/SI measurement. This additional IMR may enable the capture of the impact of SI by the CSI reporting for SBFD-capable UE.

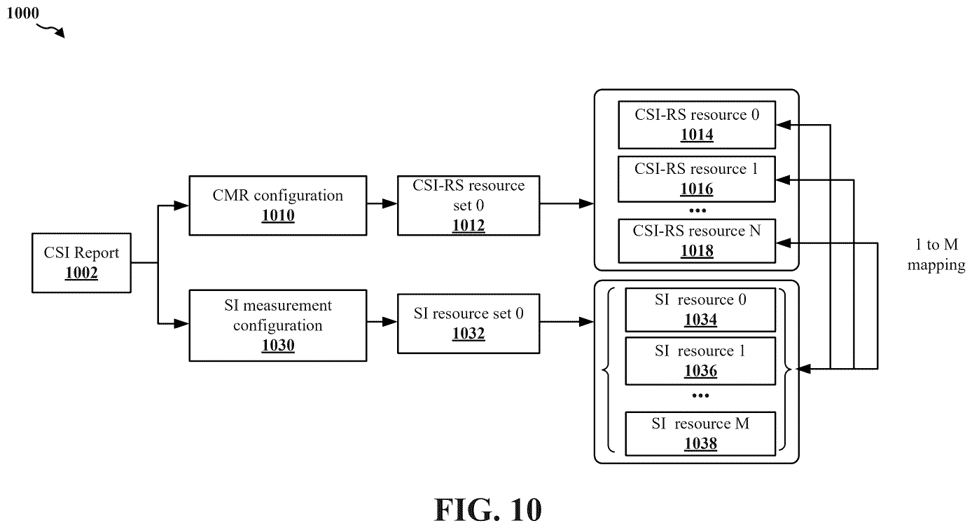

FIG. 10 is a diagram 1000 illustrating example associations between a CSI report and SI measurement resources in accordance with various aspects of the present disclosure.

As shown in FIG. 10, a CSI report 1002 may be associated with a CMR configuration 1010, which may be associated with the CSI-RS resource set 0 1012. The CSI-RS resource set 0 1012 may include one or more CSI-RS resources (e.g., CSI-RS resource 0 1014, CSI-RS resource 1 1016 through CSI-RS resource N 1018).

The CSI report 1002 may be further associated with an SI measurement configuration 1030, which may be associated with the SI resource set 0 1032. The SI resource set 0 1032 may include one or more SI measurement resources (e.g., SI resource 0 1034, SI resource 1 1036 through SI resource M 1038.

In some examples, there may be a one-to-many mapping between the SI resources (e.g., SI resource 0 1034, SI resource 1 1036 through SI resource M 1038) and the CMR resources (e.g., CSI-RS resource 0 1014, CSI-RS resource 1 1016 through CSI-RS resource N 1018). In some examples, the CSI metric in the CSI report 1002 then may be updated based on the SI measurement resources (e.g., SI resource 0 1034, SI resource 1 1036 through SI resource M 1038). In some examples, the SI measurement resources (e.g., SI resource 0 1034, SI resource 1 1036 through SI resource M 1038) may be dedicated for SI measurements. In some examples, the SI measurement resources (e.g., SI resource 0 1034, SI resource 1 1036 through SI resource M 1038) may be used for a combination of multiple interference measurements, such as the combination of CLI measurements and SI measurements.

In some aspects, several enhancements to SI measurement or CSI reporting may be provided to support implicit SI reporting. For example, one enhancement may include enhancing CSI reporting to include one or more CSI metrics based on residual SI generated based on multiple uplink transmit power hypotheses. Another enhancement may involve the determination of appropriate measurement resources for SI and the filtering of the measurement occasions depending on whether the UE is actively transmitting in the uplink. Additionally, the UE may determine one or more uplink transmit power hypotheses that will be used to compute the residual SI and the corresponding CSI metrics based on the residual SI.

In some aspects, an uplink transmit power may be used for uplink transmission, based on which the UE may compute residual SI and update the CSI metrics accordingly. In some aspects, the uplink transmit power may be configured in different ways.

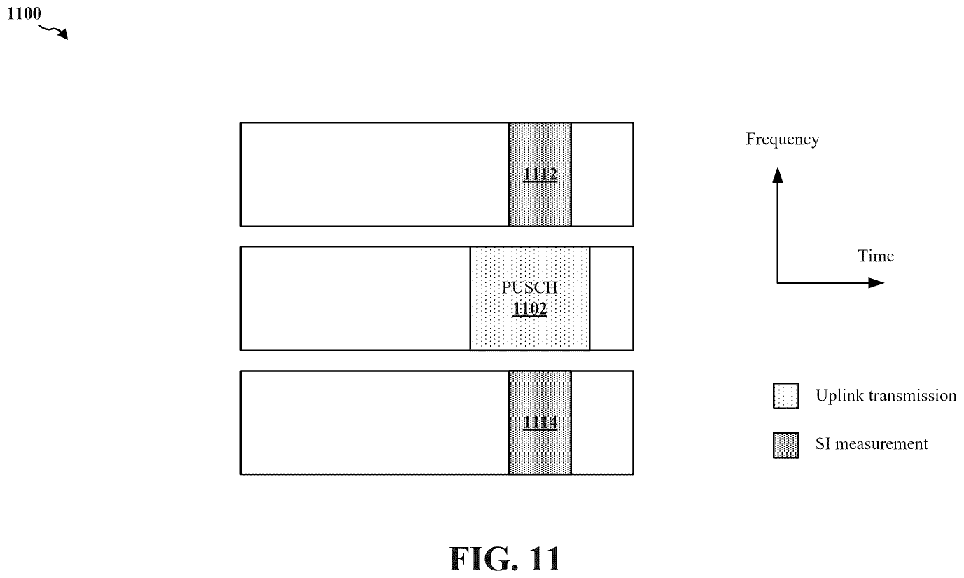

FIG. 1100 is a diagram 1100 illustrating an example of residual SI measurement in accordance with various aspects of the present disclosure. As shown in FIG. 11, in some aspects, the uplink transmit power for uplink transmission, such as the power for the transmission of PUSCH 1102, may be separately configured or signaled by following procedures such as the power control (PC) mechanisms of unified transmission configuration indicator (TCI) or UL-TCI. In this case, there is no special handling for the uplink transmit power used in residual SI measurement or calculation, and the uplink transmit power may be controlled by the network configuration and power control mechanisms.

In some aspects, a separate power control state may be used for residual SI computation (e.g., at SI measurement resource 1112, 1114). In this case, the network may configure the uplink transmit power hypothesis used for residual SI computation, which may be different from the power used in the currently scheduled uplink transmission (e.g., the transmission of PUSCH 1102). This allows the network to test different uplink transmit power hypotheses, such as using a higher transmit power for residual SI computation (e.g., at SI measurement resource 1112, 1114) than the power used for PUSCH 1102.

In some aspects, the uplink transmit power used for residual SI calculation (e.g., at SI measurement resource 1112, 1114) may be determined based on a defined rule, such as a rule defined in wireless communication standards. For example, the uplink transmit power may be defined as part of the CSI reference resource, which may represent a hypothetical physical downlink shared channel (PDSCH) used for channel quality indicator (CQI) computation, in some examples.

In some aspects, the residual SI may be computed under more than one uplink transmit power hypothesis. In this case, different transmit power levels may be defined as part of the CSI report configuration or as part of the semi-persistent (SP) or periodic uplink transmission configuration. In some examples, the uplink signal may be a sounding reference signal (SRS) transmitted with repetition, and each symbol in the repetition may be transmitted with a different power hypothesis.

In some aspects, CSI reporting mechanisms may be enhanced to allow SBFD-capable UE to report CSI that reflects the impact of SI. In some examples, when a single uplink transmit power hypothesis is used, existing CSI reporting mechanisms may be reused to reflect the impact of SI. However, to support scenarios where multiple power hypotheses are used, the CSI reporting mechanisms may be enhanced to reflect the impact of residual SI under different uplink transmit power hypotheses.

In some aspects, a CSI report may include multiple CSI metrics, each corresponding to a different uplink transmit power hypothesis. In one configuration, the multiple CSI metrics may be configured (or implemented) using the CSI report sub-configuration framework, where each CSI report sub-configuration may be associated with one uplink transmit power hypothesis of multiple uplink transmit power hypotheses.

In some examples, the different CSI report sub-configurations may share the same CMR but have different interference measurement resources (IMRs). In some examples, the different CSI report sub-configurations may share the same CMR and have the same IMR with measurements taken in different symbols.

In some examples, the CSI reporting payload may be enhanced (or expanded) to support multiple CSI metrics within a single report. In some examples, these multiple CSI metrics may respectively correspond to the SI under the multiple uplink transmit power hypotheses.

In some examples, separate CSI reports may be triggered for each power hypothesis. For example, separated CSI reports may be triggered in a manner similar to the handling of different quasi-co-location type D (QCL-D) hypotheses or beam hypotheses.

In some aspects, instead of reporting multiple CSI metrics respectively corresponding to the multiple uplink transmit power hypotheses, a CSI report may include a single CSI metric that is derived (or selected) based on multiple uplink transmit power hypotheses. In this case, the UE may need to include an indication (e.g., a power indicator) in the CSI report specifying which power hypothesis among the multiple power hypotheses was used to generate the reported CSI metric.

The UE may select the single CSI metric based on various selection criteria. In some examples, the UE may select the single CSI metric based on the interference measurement resource associated with the largest power that can result in a threshold value of desense (e.g., 1 dB desense), thereby ensuring that the worst-case self-interference results in less than the threshold level of desense (e.g., 1 dB desense). As used herein, a “desense” refers to the reduction in a receiver's sensitivity caused by interference. In some examples, the selection criteria for the single CSI metric may be based on the comparison of the MCS degradation with a defined degradation threshold. For example, the single CSI metric may be selected based on the largest uplink transmit power that will result in MCS degradation that is less than the degradation threshold. In some examples, the selection criteria may be left to the UE implementation. For example, the UE may select one CSI metric based on its internal implementation and inform the network of the selected CSI metric.

In some aspects, the UE may indicate whether a CSI report has accounted for the SI. For example, when the CSI report include one CSI metric, the UE may indicate whether the one CSI metric is selected from (or based on) multiple uplink transmit power hypotheses (e.g., selected based on the interference measurement resource associated with the largest transmit power that results in less than the threshold level (e.g., 1 dB) of desense). The indication may be implicit or explicit. For an explicit indication, parameters associated with the CSI reportQuantity may be used to signal the selected reporting configuration. For example, one or more of channel reciprocity indicator (CRI), channel quality indicator (CQI), rank indicator (RI), precoding matrix indicator (PMI), TxPowerMax may be used to indicate that the selected CSI metrics. For an implicit indication, the indication may be based on the association of the self-interference measurement resource (SIMR) with the corresponding CSI report. In this implicit method, the presence and impact of SI may be inferred through the configuration and usage of the associated SIMR in the CSI reporting process.

In some aspects, SI measurement resources (e.g., SI resource 0 1034, SI resource 1 1036 through SI resource M 1038) in the CSI report (e.g., CSI report 1002) may be configured to support the reporting of SI measurements when multiple uplink transmit power hypotheses are used.

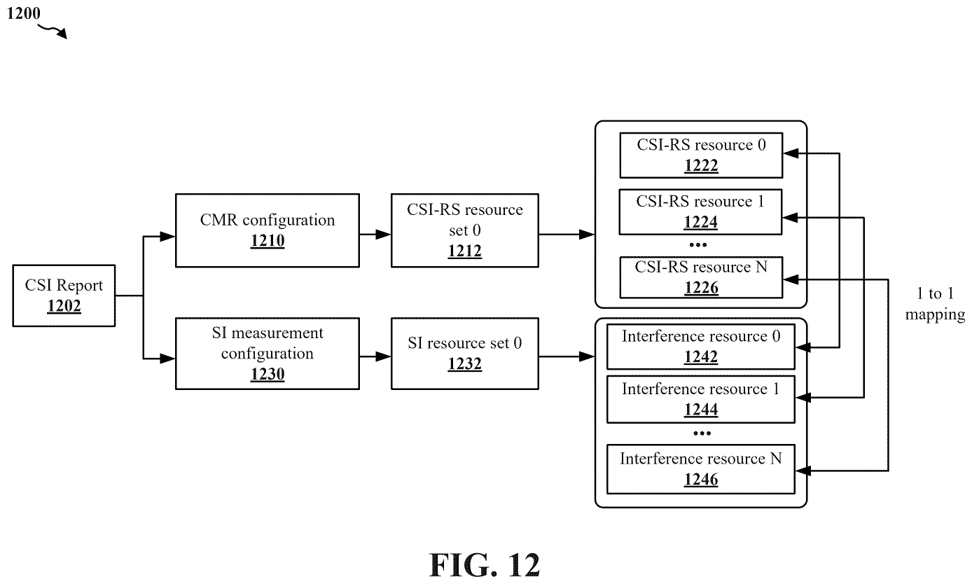

In one configuration, to support multiple power hypotheses, the SI measurement resource and the CSI-RS resource used for channel measurement may have a one-to-one correspondence. FIG. 12 is a diagram 1200 illustrating an example of a one-to-one correspondence between the SI measurement resources and CSI-RS resources in accordance with various aspects of the present disclosure. As shown in FIG. 12, a CSI report 1202 may be associated with a CMR configuration 1210, which may be associated with the CSI-RS resource set 0 1212. The CSI-RS resource set 0 1212 may include one or more CSI-RS resources (e.g., CSI-RS resource 0 1222, CSI-RS resource 1 1224 through CSI-RS resource N 1226). The CSI report 1202 may be further associated with an SI measurement configuration 1230, which may be associated with the SI resource set 0 1232. The SI resource set 0 1232 may include one or more SI measurement resources (e.g., interference resource 0 1242, interference resource 1 1244 through interference resource N 1246).

In some examples, the SI resources (e.g., interference resource 0 1242, interference resource 1 1244 through interference resource N 1246) may have a one-to-one correspondence with the CMR resources (e.g., CSI-RS resource 0 1222, CSI-RS resource 1 1224 through CSI-RS resource N 1226).

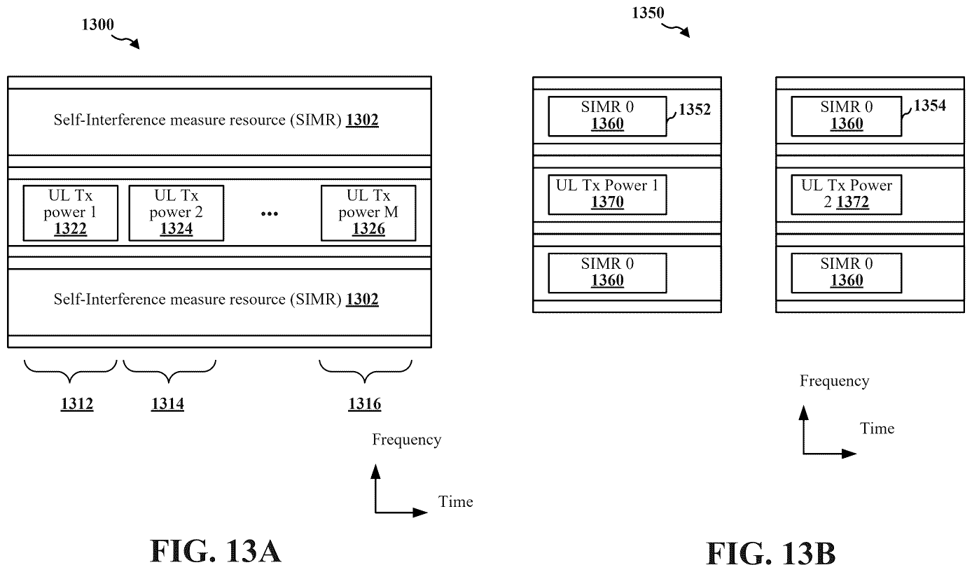

In some examples, multiple symbols may be configured within each measurement occasion. FIG. 13A is a diagram 1300 illustrating multiple symbols configured for a measurement occasion in accordance with various aspects of the present disclosure. As shown in FIG. 13A, multiple symbols (e.g., at 1312, 1314, 1316) may be configured for a SI measurement occasion (e.g., SIMR 0 1302). In some examples, the multiple symbols (e.g., at 1312, 1314, 1316) in the SI measurement occasion (e.g., SIMR 0 1302) may correspond to different uplink transmit powers (e.g., uplink transmit power 1 1322, uplink transmit power 2 1324 through uplink transmit power M 1326).

In some examples, multiple measurement occasions may be configured for a measurement resource, and these multiple measurement occasions may occur in different symbols or slots. FIG. 13B is a diagram 1350 illustrating multiple measurement occasions configured for a measurement resource in accordance with various aspects of the present disclosure. As shown in FIG. 13B, multiple measurement occasions (e.g., occasion 1352, 1354) may be configured for a measurement resource (e.g., SIMR 0 1360), and these multiple measurement occasions may occur in different symbols or slots. In some examples, different measurement occasions (e.g., occasion 1352, 1354) may correspond to different uplink transmit powers. For example, measurement occasion 1352 may correspond to uplink transmit power 1 1370, and measurement occasion 1354 may correspond to uplink transmit power 2 1372, which may be different from uplink transmit power 1 1370.

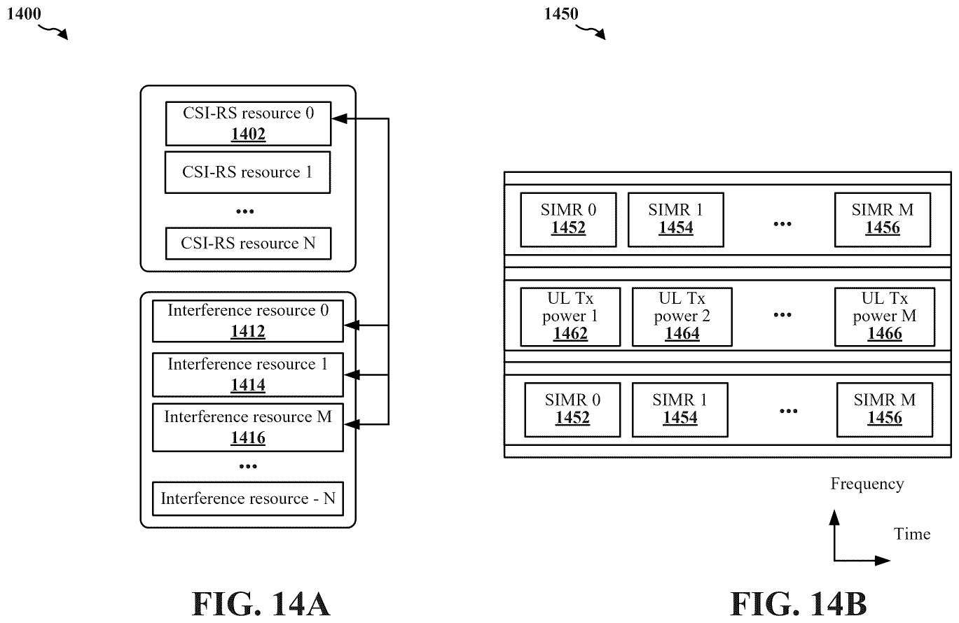

In one configuration, multiple SI measurement resources may be configured within the same set. In this case, each CSI-RS channel measurement resource may correspond to multiple SI measurement resources, and each SI measurement resource may occur in the same time as an uplink transmission with one uplink transmit power hypothesis. FIG. 14A is a diagram 1400 illustrating multiple SI measurement resources configured within the same set in accordance with various aspects of the present disclosure. As shown in FIG. 14A, multiple SI measurement resources (e.g., interference resource 0 1412, interference resource 1 1414 through interference resource M 1416) may be configured within the same set, and these SI measurement resources (e.g., interference resource 0 1412, interference resource 1 1414 through interference resource M 1416) may correspond with a CSI-RS channel measurement resource (e.g., CSI-RS resource 0 1402). FIG. 14B is a diagram 1450 illustrating example SI measurement resources relative to uplink transmissions with uplink transmit power hypotheses in accordance with various aspects of the present disclosure. As shown in FIG. 14B, each SI measurement resource (e.g., SIMR 0 1452, SIMR 1 1454 through SIMR M 1456) may occur in the same time as an uplink transmission with one uplink transmit power hypothesis (e.g., uplink transmit power 1 1462, uplink transmit power 2 1464 through uplink transmit power M 1466).

In one configuration, each SI measurement resource may be linked to all channel measurement resources (CMRs), which is similar to the design used for NZP CSI-RS for interference measurement. For example, referring to FIG. 10, each SI measurement resource (e.g., SI resource 1 1036) may be linked to all CMRs (e.g., CSI-RS resource 0 1014, CSI-RS resource 1 1016 through CSI-RS resource N 1018).

In one configuration, the SI measurement may be based on the CMRs and an additional SI IMR is not needed. As an example, residual SI may be accounted for during the estimation of the noise-plus-interference covariance matrix (Rnn) based on the CSI-RS resource.

In some aspects, some restrictions may be applied to the SI measurements for CSI reporting for SBFD-capable UE. In some examples, the network (e.g., gNB) may be aware of whether an uplink signal is being transmitted, and this information may be used for SI measurements. In some examples, such as in configured grant (CG) physical uplink shared channel (CG-PUSCH), the UE may transmit when traffic is available or when uplink cancellation occurs. In these cases, the measurement resource may not capture the impact of SI, as no uplink signal is transmitted during the measurement occasion.

In these cases, a configuration parameter, referred to as “timeRestrictionForInterferenceMeasurements,” may be used. This parameter may either be configured or left not configured. In some examples, the presence of this configuration (e.g., parameter timeRestrictionForInterferenceMeasurements being configured) may indicate that CSI reporting is based on single-shot interference measurements.

In some examples, when timeRestrictionForInterferenceMeasurements is configured, it may leave it up to the network implementation to determine whether SI was accounted for in the reported CSI. In some examples, when timeRestrictionForInterferenceMeasurements is configured, an explicit one-bit indication may be included in the CSI report to indicate whether SI was accounted for when computing of the CSI metrics.

In some examples, if timeRestrictionForInterferenceMeasurements is not configured, all measurement occasions, regardless of whether the SI is present, may be used for CSI computation. In some examples, if timeRestrictionForInterferenceMeasurements is not configured, the CSI computation may be based on the measurement occasions where SI interference is used for CSI computation, excluding the measurement occasions without SI interference.

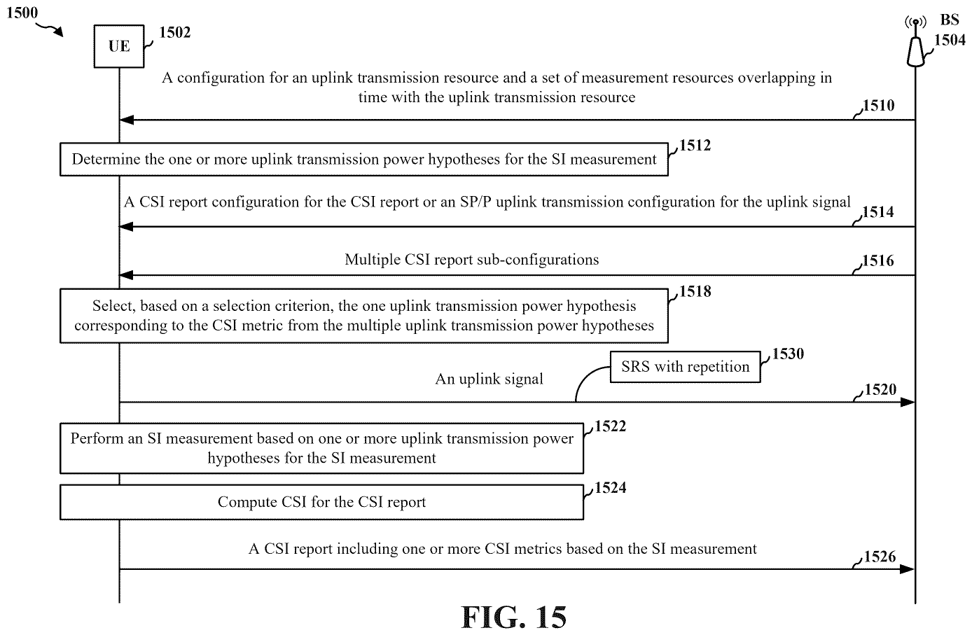

FIG. 15 is a call flow diagram 1500 illustrating a method of wireless communication in accordance with various aspects of this present disclosure. Various aspects are described in connection with a UE 1502 and a base station 1504. The aspects may be performed by the UE 1502 or the base station 1504 in aggregation and/or by one or more components of a base station 1504 (e.g., a CU 110, a DU 130, and/or an RU 140).

As shown in FIG. 15, at 1510, the UE 1502 may receive from base station 1504 a configuration for an uplink transmission resource and a set of measurement resources. In some examples, the set of measurement resources may overlap in time with the uplink transmission resource. For example, referring to FIG. 14B, the uplink transmission resource may correspond to the transmission resources at 1462, 1464, 1466, and the set of measurement resources may include SIMR 0 1452, SIMR 1 1454 through SIMR M 1456.

In some examples, each measurement resource of the set of measurement resources may correspond to one CSI-RS resource of one or more CSI-RS resources for a channel measurement. For example, in FIG. 10, a measurement resource (e.g., SI resource 1 1036) may correspond to multiple CSI-RS resources (e.g., CSI-RS resource 0 1014, CSI-RS resource 1 1016 through CSI-RS resource N 1018). In FIG. 12, each measurement resource (e.g., interference resource 0 1042) may correspond to one CSI-RS resource (e.g., CSI-RS resource 0 1222).

In some examples, the one or more uplink transmission power hypotheses may correspond to one or more symbols in one measurement occasion in the set of measurement resources. For example, in FIG. 13A, the one or more uplink transmission power hypotheses (e.g., uplink transmit power 1 1322, uplink transmit power 2 1324 through uplink transmit power M 1326) may correspond to one or more symbols (e.g., symbols 1312, 1314, 1316) in one measurement occasion (e.g., at 1302).

In some examples, the one or more uplink transmission power hypotheses may correspond to one or more measurement occasions in one measurement resource of the set of measurement resources. For example, in FIG. 13B, the one or more uplink transmission power hypotheses (e.g., uplink transmit power 1 1370, uplink transmit power 2 1372) may correspond to one or more measurement occasions (e.g., measurement occasions at 1352, 1354) in one measurement resource (e.g., SIMR 0 1360).

In some examples, the set of measurement resources may be located in a resource set, and a CSI-RS channel measurement resource may correspond to the set of measurement resources. For example, in FIG. 14A, CSI-RS resource 0 1402 may correspond to the set of measurement resources (e.g., interference resource 0 1412, interference resource 1 1414 through interference resource M 1416).

In some examples, each measurement resource of the set of measurement resources may be associated with all channel measurement resources of the UE 1502.

At 1516, the UE 1502 may receive multiple CSI report sub-configurations. Each CSI report sub-configuration of the multiple CSI report sub-configurations may correspond to one uplink transmission power hypothesis of the multiple uplink transmission power hypotheses.

In some examples, the multiple CSI report sub-configurations may correspond to a CMR, and the multiple CSI report sub-configurations may correspond to different IMR.

At 1512, the UE 1502 may determine the one or more uplink transmission power hypotheses for the SI measurement. In some examples, the one or more uplink transmission power hypotheses may be determined based on a power control state for the SI measurement. In some examples, the one or more uplink transmission power hypotheses may be determined based on a defined rule, such as the rules in wireless communication standards. In some examples, the one or more uplink transmission power hypotheses may be independent from the uplink power.

At 1518, the UE 1502 may select, based on a selection criterion, the one uplink transmission power hypothesis corresponding to the CSI metric from the multiple uplink transmission power hypotheses. In some examples, the selection criterion may be based on one or more of: a threshold reduction in a receiver sensitivity, a modulation and coding scheme (MCS) degradation threshold. In some examples, the selection criterion may be based on an implementation on the UE 1502.

At 1514, the UE 1502 may receive from base station 1504 a CSI report configuration for the CSI report or a semi-persistent or periodic (SP/P) uplink transmission configuration for the uplink signal. The CSI report configuration or the SP/P uplink transmission configuration may indicate the multiple uplink transmission power hypotheses.

At 1520, the UE 1502 may transmit an uplink signal using the uplink transmission resource. In some examples, the uplink power for the uplink signal may be based on a power control configuration from base station 1504.

In some examples, the uplink signal may include an SRS with repetition (e.g., 1530). When transmitting the uplink signal (e.g., at 1520), the UE 1502 may transmit multiple symbols associated with the uplink signal respectively using the multiple uplink transmission power hypotheses.

At 1522, the UE 1502 may perform an SI measurement based on one or more uplink transmission power hypotheses for the SI measurement. In some examples, the one or more uplink transmission power hypotheses for the SI measurement may respectively correspond to the set of measurement resources. For example, in FIG. 14B, the UE may perform an SI measurement based on one or more uplink transmission power hypotheses (e.g., uplink transmit power 1 1462, uplink transmit power 2 1464 through uplink transmit power M 1466) for the SI measurement.

At 1524, the UE 1502 may compute CSI for the CSI report. In some examples, the UE 1502 may compute CSI for the CSI report using all measurement occasions associated with the set of measurement resources. In some examples, the UE 1502 may compute CSI for the CSI report using one or more measurement occasions associated with the set of measurement resources, and the one or more measurement occasions may be associated with an S1 interference.

At 1526, the UE 1502 may transmit a CSI report to the base station 1504. In some examples, the CSI repot may include one or more CSI metrics based on the SI measurement.

In some examples, the one or more uplink transmission power hypotheses (e.g., at 1522) may include multiple uplink transmission power hypotheses, and the CSI report may include one CSI metric based on one uplink transmission power hypothesis of the multiple uplink transmission power hypotheses.

In some examples, the CSI report (e.g., at 1526) may include a power indicator for the one uplink transmission power hypothesis of the multiple uplink transmission power hypotheses corresponding to the one CSI metric.

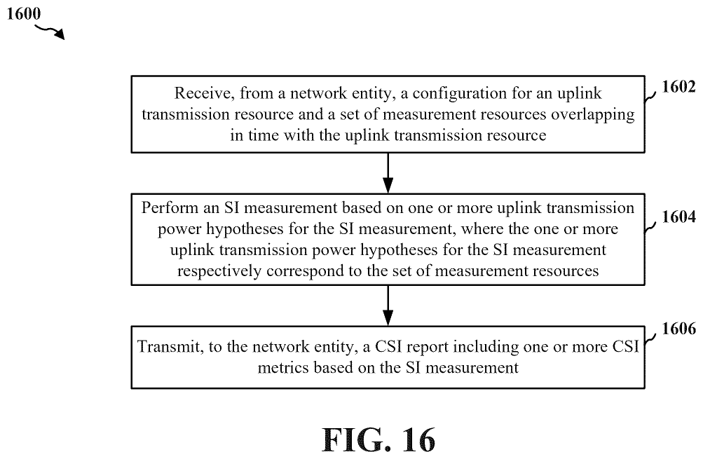

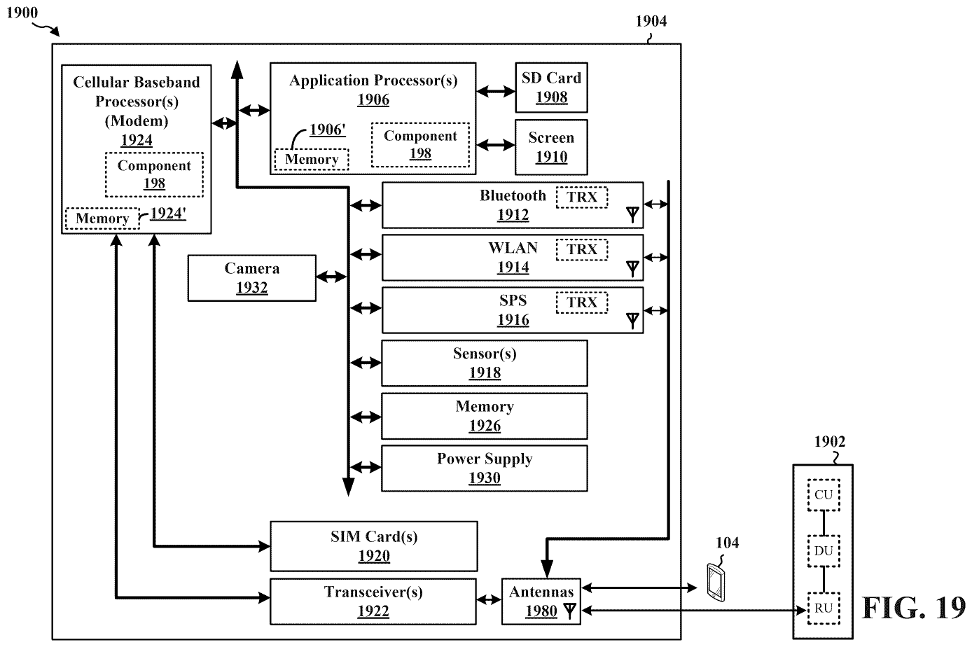

FIG. 16 is a flowchart 1600 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 1504; or the network entity 1902 in the hardware implementation of FIG. 19). The UE may be the UE 104, 350, 1502, or the apparatus 1904 in the hardware implementation of FIG. 19. By incorporating the impact of SI into CSI metrics, the methods enable more accurate and efficient CSI reporting for SBFD capable UE. Additionally, by enhancing CSI reporting to account for the impact of SI under multiple uplink transmit power hypotheses, the methods enable the network to better adapt to varying SI conditions at the UE, thereby allowing for more accurate scheduling and resource allocation.

As shown in FIG. 16, at 1602, the UE may receive, from a network entity, a configuration for an uplink transmission resource and a set of measurement resources overlapping in time with the uplink transmission resource. FIG. 12, FIG. 13A, FIG. 13B, FIG. 14A, FIG. 14B, and FIG. 15 illustrate various aspects of the steps in connection with flowchart 1600. For example, referring to FIG. 15, the UE 1502 may, at 1510, receive from a network entity (e.g., base station 1504) a configuration for an uplink transmission resource and a set of measurement resources overlapping in time with the uplink transmission resource. Referring to FIG. 14B, the uplink transmission resource may correspond to the transmission resources at 1462, 1464, 1466, and the set of measurement resources may include SIMR 0 1452, SIMR 1 1454 through SIMR M 1456. In some aspects, 1602 may be performed by the CSI report component 198.

At 1604, the UE may perform an SI measurement based on one or more uplink transmission power hypotheses for the SI measurement. The one or more uplink transmission power hypotheses for the SI measurement may respectively correspond to the set of measurement resources. For example, referring to FIG. 15, the UE 1502 may, at 1522, perform an SI measurement based on one or more uplink transmission power hypotheses for the SI measurement. Referring to FIG. 14B, the UE may perform an SI measurement based on one or more uplink transmission power hypotheses (e.g., uplink transmit power 1 1462, uplink transmit power 2 1464 through uplink transmit power M 1466) for the SI measurement. The one or more uplink transmission power hypotheses (e.g., uplink transmit power 1 1462, uplink transmit power 2 1464 through uplink transmit power M 1466) for the SI measurement may respectively correspond to the set of measurement resources (e.g., SIMR 0 1452, SIMR 1 1454 through SIMR M 1456). In some aspects, 1604 may be performed by the CSI report component 198.

At 1606, the UE may transmit, to the network entity, a CSI report including one or more CSI metrics based on the SI measurement. For example, referring to FIG. 15, the UE 1502 may, at 1526, transmit to the network entity (e.g., base station 1504) a CSI report including one or more CSI metrics based on the SI measurement. In some aspects, 1606 may be performed by the CSI report component 198.

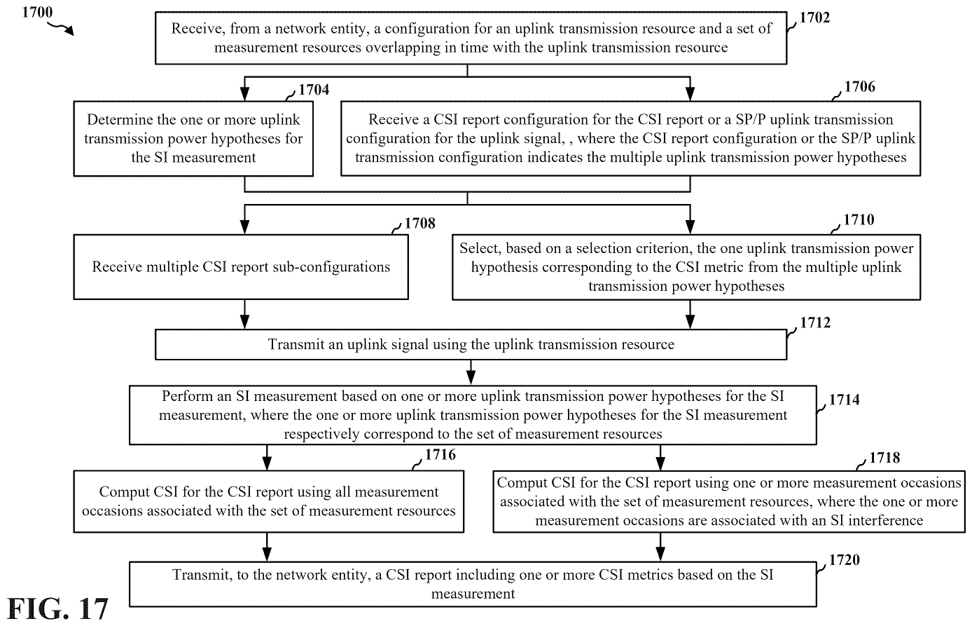

FIG. 17 is a flowchart 1700 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 1504; or the network entity 1902 in the hardware implementation of FIG. 19). The UE may be the UE 104, 350, 1502, or the apparatus 1904 in the hardware implementation of FIG. 19. By incorporating the impact of SI into CSI metrics, the methods enable more accurate and efficient CSI reporting for SBFD capable UE. Additionally, by enhancing CSI reporting to account for the impact of SI under multiple uplink transmit power hypotheses, the methods enable the network to better adapt to varying SI conditions at the UE, thereby allowing for more accurate scheduling and resource allocation.

As shown in FIG. 17, at 1702, the UE may receive, from a network entity, a configuration for an uplink transmission resource and a set of measurement resources overlapping in time with the uplink transmission resource. FIG. 10, FIG. 12, FIG. 13A, FIG. 13B, FIG. 14A, FIG. 14B, and FIG. 15 illustrate various aspects of the steps in connection with flowchart 1700. For example, referring to FIG. 15, the UE 1502 may, at 1510, receive from a network entity (e.g., base station 1504) a configuration for an uplink transmission resource and a set of measurement resources overlapping in time with the uplink transmission resource. Referring to FIG. 14B, the uplink transmission resource may correspond to the transmission resources at 1462, 1464, 1466, and the set of measurement resources may include SIMR 0 1452, SIMR 1 1454 through SIMR M 1456. In some aspects, 1702 may be performed by the CSI report component 198.

At 1714, the UE may perform an SI measurement based on one or more uplink transmission power hypotheses for the SI measurement. The one or more uplink transmission power hypotheses for the SI measurement may respectively correspond to the set of measurement resources. For example, referring to FIG. 15, the UE 1502 may, at 1522, perform an SI measurement based on one or more uplink transmission power hypotheses for the SI measurement. Referring to FIG. 14B, the UE may perform an SI measurement based on one or more uplink transmission power hypotheses (e.g., uplink transmit power 1 1462, uplink transmit power 2 1464 through uplink transmit power M 1466) for the SI measurement. The one or more uplink transmission power hypotheses (e.g., uplink transmit power 1 1462, uplink transmit power 2 1464 through uplink transmit power M 1466) for the SI measurement may respectively correspond to the set of measurement resources (e.g., SIMR 0 1452, SIMR 1 1454 through SIMR M 1456). In some aspects, 1714 may be performed by the CSI report component 198.

At 1720, the UE may transmit, to the network entity, a CSI report including one or more CSI metrics based on the SI measurement. For example, referring to FIG. 15, the UE 1502 may, at 1526, transmit to the network entity (e.g., base station 1504) a CSI report including one or more CSI metrics based on the SI measurement. In some aspects, 1720 may be performed by the CSI report component 198.

In some aspects, at 1712, the UE may transmit an uplink signal using the uplink transmission resource. The uplink power for the uplink signal may be based on a power control configuration from the network entity. For example, referring to FIG. 15, the UE 1502 may, at 1520, transmit an uplink signal using the uplink transmission resource. The uplink power for the uplink signal may be based on a power control configuration from the network entity (e.g., base station 1504). In some aspects, 1712 may be performed by the CSI report component 198.

In some aspects, at 1704, the UE may determine, based on a power control state for the SI measurement, the one or more uplink transmission power hypotheses for the SI measurement. The one or more uplink transmission power hypotheses may be independent from the uplink power. For example, referring to FIG. 15, the UE 1502 may, at 1512, determine, based on a power control state for the SI measurement, the one or more uplink transmission power hypotheses for the SI measurement. The one or more uplink transmission power hypotheses (e.g., at 1512) may be independent from the uplink power for transmitting the uplink signal at 1520. In some aspects, 1704 may be performed by the CSI report component 198.

In some aspects, to determine the one or more uplink transmission power hypotheses for the SI measurement (e.g., at 1704), the UE may determine, based on a defined rule, the one or more uplink transmission power hypotheses for the SI measurement. For example, referring to FIG. 15, the UE 1502 may, at 1512, determine the one or more uplink transmission power hypotheses for the SI measurement based on a defined rule (e.g., defined rules in wireless communication standards).

In some aspects, the one or more uplink transmission power hypotheses may include multiple uplink transmission power hypotheses. At 1706, the UE may receive, from the network entity, a CSI report configuration for the CSI report or a semi-persistent or periodic (SP/P) uplink transmission configuration for the uplink signal. The CSI report configuration or the SP/P uplink transmission configuration may indicate the multiple uplink transmission power hypotheses. For example, referring to FIG. 13A, the one or more uplink transmission power hypotheses may include multiple uplink transmission power hypotheses (e.g., uplink transmit power 1 1322, uplink transmit power 2 1324, uplink transmit power M 1326). At 1514, the UE 1502 may receive from the network entity (e.g., base station 1504) a CSI report configuration for the CSI report or an SP/P uplink transmission configuration for the uplink signal. The CSI report configuration or the SP/P uplink transmission configuration may indicate the multiple uplink transmission power hypotheses (e.g., uplink transmit power 1 1322, uplink transmit power 2 1324, uplink transmit power M 1326). In some aspects, 1706 may be performed by the CSI report component 198.

In some aspects, the uplink signal may include a sounding reference signal (SRS) with repetition. To transmit the uplink signal (e.g., at 1712), the UE may transmit multiple symbols associated with the uplink signal respectively using the multiple uplink transmission power hypotheses. For example, referring to FIG. 15, the uplink signal (e.g., at 1520) may include an SRS with repetition. In FIG. 13A, the UE may transmit multiple symbols (e.g., symbols 1312, 1314, 1316) associated with the uplink signal respectively using the multiple uplink transmission power hypotheses (e.g., uplink transmit power 1 1322, uplink transmit power 2 1324, uplink transmit power M 1326). In some aspects, 1712 may be performed by the CSI report component 198.

In some aspects, the one or more uplink transmission power hypotheses may include multiple uplink transmission power hypotheses, and the CSI report (e.g., at 1720) may include multiple CSI metrics respectively corresponding to the multiple uplink transmission power hypotheses. For example, referring to FIG. 13A, the one or more uplink transmission power hypotheses may include multiple uplink transmission power hypotheses (e.g., uplink transmit power 1 1322, uplink transmit power 2 1324, uplink transmit power M 1326). The CSI report (e.g., CSI report 1202) may include multiple CSI metrics respectively corresponding to the multiple uplink transmission power hypotheses.

In some aspects, at 1708, the UE may receive multiple CSI report sub-configurations. Each CSI report sub-configuration of the multiple CSI report sub-configurations may correspond to one uplink transmission power hypothesis of the multiple uplink transmission power hypotheses. For example, referring to FIG. 15, the UE 1502 may, at 1516, receive multiple CSI report sub-configurations. Each CSI report sub-configuration of the multiple CSI report sub-configurations may correspond to one uplink transmission power hypothesis of the multiple uplink transmission power hypotheses. In some aspects, 1708 may be performed by the CSI report component 198.

In some aspects, the multiple CSI report sub-configurations may correspond to a CMR, and the multiple CSI report sub-configurations (e.g., at 1708) may correspond to different interference measurement resources (IMR). For example, referring to FIG. 14A, the multiple CSI report sub-configurations may correspond to a CMR (e.g., CSI-RS resource 0 1402), and the multiple CSI report sub-configurations may correspond to different IMR (e.g., interference resource 0 1412, interference resource 1 1414, interference resource M 1416).

In some aspects, each uplink transmission power hypothesis of the multiple uplink transmission power hypotheses may correspond to a trigger event corresponding to triggering the CSI report. For example, referring to FIG. 14B, each uplink transmission power hypothesis of the multiple uplink transmission power hypotheses (e.g., uplink transmit power 1 1462, uplink transmit power 2 1464 through uplink transmit power M 1466) may correspond to a trigger event corresponding to triggering the CSI report.

In some aspects, the one or more uplink transmission power hypotheses may include multiple uplink transmission power hypotheses, and the CSI report (e.g., at 1720) may include one CSI metric based on one uplink transmission power hypothesis of the multiple uplink transmission power hypotheses. For example, referring to FIG. 14B, the one or more uplink transmission power hypotheses may include multiple uplink transmission power hypotheses (e.g., uplink transmit power 1 1462, uplink transmit power 2 1464 through uplink transmit power M 1466), and the CSI report (e.g., at 1526) may include one CSI metric based on one uplink transmission power hypothesis of the multiple uplink transmission power hypotheses (e.g., uplink transmit power 1 1462, uplink transmit power 2 1464 through uplink transmit power M 1466).

In some aspects, the CSI report may include a power indicator for the one uplink transmission power hypothesis of the multiple uplink transmission power hypotheses corresponding to the one CSI metric. For example, referring to FIG. 15, the CSI report (e.g., at 1526) may include a power indicator for the one uplink transmission power hypothesis of the multiple uplink transmission power hypotheses (e.g., uplink transmit power 1 1462, uplink transmit power 2 1464 through uplink transmit power M 1466) corresponding to the one CSI metric.

In some aspects, at 1710, the UE may select, based on a selection criterion, the one uplink transmission power hypothesis corresponding to the CSI metric from the multiple uplink transmission power hypotheses. For example, referring to FIG. 15, the UE 1502 may, at 1518, select the one uplink transmission power hypothesis corresponding to the CSI metric from the multiple uplink transmission power hypotheses based on a selection criterion. In some aspects, 1710 may be performed by the CSI report component 198.

In some aspects, the selection criterion (e.g., at 1710) may be based on one or more of: a threshold reduction in a receiver sensitivity, a modulation and coding scheme (MCS) degradation threshold, or an implementation on the UE. For example, referring to FIG. 15, the selection criterion (e.g., at 1518) may be based on one or more of: a threshold reduction in a receiver sensitivity (e.g., the sensitivity of UE 1502), an MCS degradation threshold, or an implementation on the UE 1502.

In some aspects, the inclusion of the one or more CSI metrics based on the SI measurement in the CSI report may be based on a CSI report configuration or a self-interference measurement resource (SIMR) associated with the CSI report. For example, referring to FIG. 15, the inclusion of the one or more CSI metrics based on the SI measurement in the CSI report (e.g., at 1526) may be based on a CSI report configuration or an SIMR associated with the CSI report.

In some aspects, each measurement resource of the set of measurement resources may correspond to one CSI-RS resource of one or more CSI-RS resources for a channel measurement. The one or more uplink transmission power hypotheses may correspond to: one or more symbols in one measurement occasion in the set of measurement resources, or one or more measurement occasions in one measurement resource of the set of measurement resources. For example, referring to FIG. 14A, each measurement resource of the set of measurement resources (e.g., interference resource 0 1412, interference resource 1 1414, interference resource M 1416) may correspond to one CSI-RS resource (e.g., CSI-RS resource 0 1402). Referring to FIG. 13A, the one or more uplink transmission power hypotheses (e.g., uplink transmit power 1 1322, uplink transmit power 2 1324, uplink transmit power M 1326) may correspond to: one or more symbols (e.g., symbols 1312, 1314, 1316) in one measurement occasion (e.g., at 1302). Referring to FIG. 13B, the one or more uplink transmission power hypotheses (e.g., uplink transmit power 1 1370, uplink transmit power 2 1372) may correspond to: one or more measurement occasions (e.g., at 1352, 1354) in one measurement resource of the set of measurement resources.

In some aspects, the set of measurement resources may be located in a resource set, and the CSI-RS channel measurement resource may correspond to the set of measurement resources. For example, referring to FIG. 15, the set of measurement resources (e.g., at 1510) may be located in a resource set, and the CSI-RS channel measurement resource (e.g., CSI-RS resource 0 1402) may correspond to the set of measurement resources.

In some aspects, each measurement resource of the set of measurement resources may be associated with all channel measurement resources of the UE. For example, referring to FIG. 15, each measurement resource of the set of measurement resources (e.g., at 1510) may be associated with all channel measurement resources of the UE 1502.

In some aspects, the set of measurement resources may be based on channel measurement resources of the UE. For example, referring to FIG. 15, the set of measurement resources (e.g., at 1510) may be based on channel measurement resources of the UE 1502.

In some aspects, the CSI report (e.g., at 1720) may include an interference indication bit indicative of an inclusion or an absence of the SI measurement in the CSI report. For example, referring to FIG. 15, the CSI report (e.g., at 1526) may include an interference indication bit indicative of an inclusion or an absence of the SI measurement in the CSI report.

In some aspects, at 1716, the UE may compute CSI for the CSI report using all measurement occasions associated with the set of measurement resources. For example, referring to FIG. 15, the UE 1502 may, at 1524, compute CSI for the CSI report using all measurement occasions associated with the set of measurement resources. In some aspects, 1716 may be performed by the CSI report component 198. In some aspects, at 1718, the UE may compute CSI for the CSI report using one or more measurement occasions associated with the set of measurement resources. The one or more measurement occasions may be associated with an S1 interference. For example, referring to FIG. 15, the UE 1502 may, at 1524, compute CSI for the CSI report using one or more measurement occasions associated with the set of measurement resources. The one or more measurement occasions may be associated with an S1 interference. In some aspects, 1718 may be performed by the CSI report component 198.

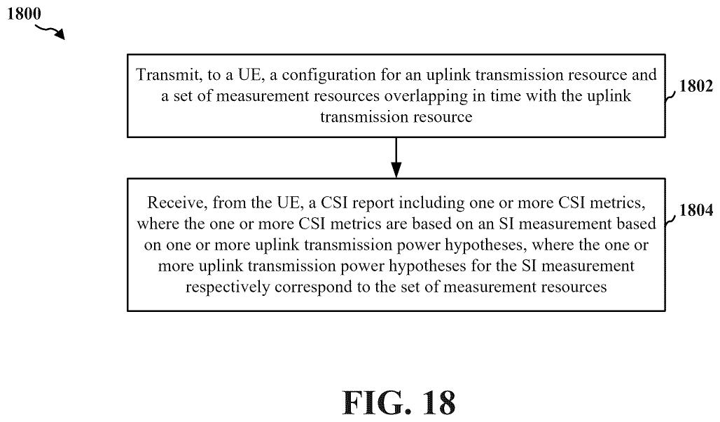

FIG. 18 is a flowchart 1800 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 1504; or the network entity 1902 in the hardware implementation of FIG. 19). The UE may be the UE 104, 350, 1502, or the apparatus 1904 in the hardware implementation of FIG. 19. By incorporating the impact of SI into CSI metrics, the methods enable more accurate and efficient CSI reporting for SBFD capable UE. Additionally, by enhancing CSI reporting to account for the impact of SI under multiple uplink transmit power hypotheses, the methods enable the network to better adapt to varying SI conditions at the UE, thereby allowing for more accurate scheduling and resource allocation.

As shown in FIG. 18, at 1802, the network entity may transmit, to a UE, a configuration for an uplink transmission resource and a set of measurement resources overlapping in time with the uplink transmission resource. FIG. 12, FIG. 13A, FIG. 13B, FIG. 14A, FIG. 14B, and FIG. 15 illustrate various aspects of the steps in connection with flowchart 1800. For example, referring to FIG. 15, the network entity (e.g., base station 1504) may, at 1510, transmit to a UE 1502 a configuration for an uplink transmission resource and a set of measurement resources overlapping in time with the uplink transmission resource. In some aspects, 1802 may be performed by the CSI report component 199.

At 1804, the network entity may receive, from the UE, a CSI report including one or more CSI metrics. The one or more CSI metrics may be based on an SI measurement based on one or more uplink transmission power hypotheses, and the one or more uplink transmission power hypotheses for the SI measurement respectively may correspond to the set of measurement resources. For example, referring to FIG. 15, the network entity (e.g., base station 1504) may, at 1526, receive, from the UE 1502, a CSI report including one or more CSI metrics. The one or more CSI metrics may be based on an SI measurement based on one or more uplink transmission power hypotheses, and the one or more uplink transmission power hypotheses for the SI measurement respectively may correspond to the set of measurement resources. In some aspects, 1804 may be performed by the CSI report component 199.

In some aspects, the network entity may receive, from the UE, an uplink signal using the uplink transmission resource. The uplink power for the uplink signal may be based on a power control configuration from the network entity. For example, referring to FIG. 15, the network entity (e.g., base station 1504) may, at 1520, receive, from the UE 1502, an uplink signal using the uplink transmission resource. The uplink power for the uplink signal may be based on a power control configuration from the network entity.

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include at least one cellular baseband processor (or processing circuitry) 1924 (also referred to as a modem) coupled to one or more transceivers 1922 (e.g., cellular RF transceiver). The cellular baseband processor(s) (or processing circuitry) 1924 may include at least one on-chip memory (or memory circuitry) 1924′. In some aspects, the apparatus 1904 may further include one or more subscriber identity modules (SIM) cards 1920 and at least one application processor (or processing circuitry) 1906 coupled to a secure digital (SD) card 1908 and a screen 1910. The application processor(s) (or processing circuitry) 1906 may include on-chip memory (or memory circuitry) 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor(s) (or processing circuitry) 1924 communicates through the transceiver(s) 1922 via one or more antennas 1980 with the UE 104 and/or with an RU associated with a network entity 1902. The cellular baseband processor(s) (or processing circuitry) 1924 and the application processor(s) (or processing circuitry) 1906 may each include a computer-readable medium/memory (or memory circuitry) 1924′, 1906′, respectively. The additional memory modules 1926 may also be considered a computer-readable medium/memory (or memory circuitry). Each computer-readable medium/memory (or memory circuitry) 1924′, 1906′, 1926 may be non-transitory. The cellular baseband processor(s) (or processing circuitry) 1924 and the application processor(s) (or processing circuitry) 1906 are each responsible for general processing, including the execution of software stored on the computer-readable medium/memory (or memory circuitry). The software, when executed by the cellular baseband processor(s) (or processing circuitry) 1924/application processor(s) (or processing circuitry) 1906, causes the cellular baseband processor(s) (or processing circuitry) 1924/application processor(s) (or processing circuitry) 1906 to perform the various functions described supra. The cellular baseband processor(s) (or processing circuitry) 1924 and the application processor(s) (or processing circuitry) 1906 are configured to perform the various functions described supra based at least in part of the information stored in the memory (or memory circuitry). That is, the cellular baseband processor(s) (or processing circuitry) 1924 and the application processor(s) (or processing circuitry) 1906 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1924/application processor(s) (or processing circuitry) 1906 when executing software. The cellular baseband processor(s) (or processing circuitry) 1924/application processor(s) (or processing circuitry) 1906 may be a component of the UE 350 and may include the at least one memory 360 and/or at least one of the TX processor 368, the RX processor 356, and the controller/processor 359. In one configuration, the apparatus 1904 may be at least one processor chip (modem and/or application) and include just the cellular baseband processor(s) (or processing circuitry) 1924 and/or the application processor(s) (or processing circuitry) 1906, and in another configuration, the apparatus 1904 may be the entire UE (e.g., see UE 350 of FIG. 3) and include the additional modules of the apparatus 1904.

As discussed supra, the component 198 may be configured to receive, from a network entity, a configuration for an uplink transmission resource and a set of measurement resources overlapping in time with the uplink transmission resource; perform an SI measurement based on one or more uplink transmission power hypotheses for the SI measurement, where the one or more uplink transmission power hypotheses for the SI measurement respectively correspond to the set of measurement resources; and transmit, to the network entity, a CSI report including one or more CSI metrics based on the SI measurement. The component 198 may be further configured to perform any of the aspects described in connection with the flowcharts in FIG. 16 and FIG. 17, and/or performed by the UE 1502 in FIG. 15. The component 198 may be within the cellular baseband processor(s) (or processing circuitry) 1924, the application processor(s) (or processing circuitry) 1906, or both the cellular baseband processor(s) (or processing circuitry) 1924 and the application processor(s) (or processing circuitry) 1906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1904 may include a variety of components configured for various functions. In one configuration, the apparatus 1904, and in particular the cellular baseband processor(s) (or processing circuitry) 1924 and/or the application processor(s) (or processing circuitry) 1906, includes means for receiving, from a network entity, a configuration for an uplink transmission resource and a set of measurement resources overlapping in time with the uplink transmission resource; means for performing an SI measurement based on one or more uplink transmission power hypotheses for the SI measurement, where the one or more uplink transmission power hypotheses for the SI measurement respectively correspond to the set of measurement resources; and means for transmitting, to the network entity, a CSI report including one or more CSI metrics based on the SI measurement. The apparatus 1904 may further include means for performing any of the aspects described in connection with the flowcharts in FIG. 16 and FIG. 17, and/or aspects performed by the UE 1502 in FIG. 15. The means may be the component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

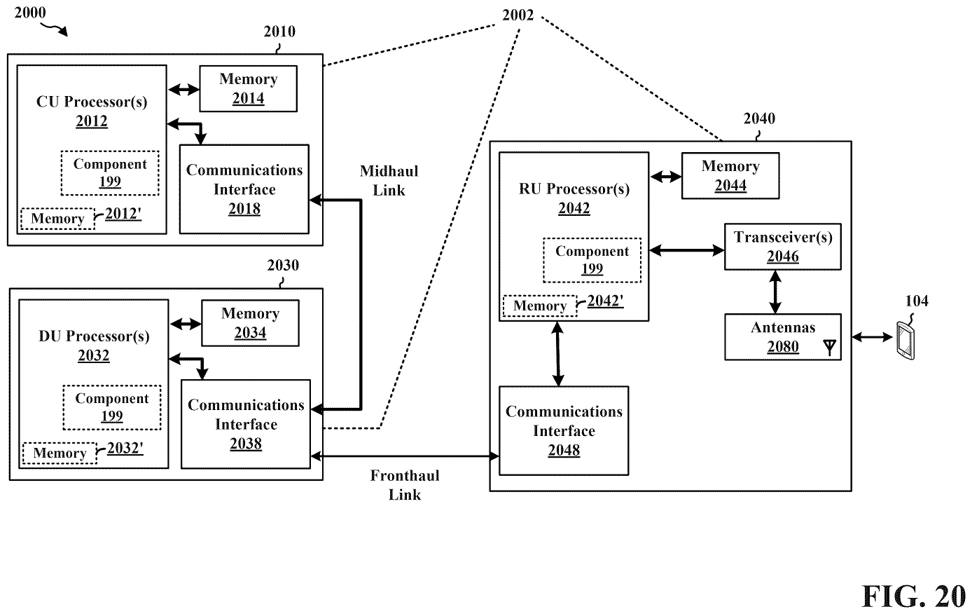

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include at least one CU processor (or processing circuitry) 2012. The CU processor(s) (or processing circuitry) 2012 may include on-chip memory (or memory circuitry) 2012′. In some aspects, the CU 2010 may further include additional memory modules 2014 and a communications interface 2018. The CU 2010 communicates with the DU 2030 through a midhaul link, such as an F1 interface. The DU 2030 may include at least one DU processor (or processing circuitry) 2032. The DU processor(s) (or processing circuitry) 2032 may include on-chip memory (or memory circuitry) 2032′. In some aspects, the DU 2030 may further include additional memory modules 2034 and a communications interface 2038. The DU 2030 communicates with the RU 2040 through a fronthaul link. The RU 2040 may include at least one RU processor (or processing circuitry) 2042. The RU processor(s) (or processing circuitry) 2042 may include on-chip memory (or memory circuitry) 2042′. In some aspects, the RU 2040 may further include additional memory modules 2044, one or more transceivers 2046, antennas 2080, and a communications interface 2048. The RU 2040 communicates with the UE 104. The on-chip memory (or memory circuitry) 2012′, 2032′, 2042′ and the additional memory modules 2014, 2034, 2044 may each be considered a computer-readable medium/memory (or memory circuitry). Each computer-readable medium/memory (or memory circuitry) may be non-transitory. Each of the processors (or processing circuitry) 2012, 2032, 2042 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a UE, a configuration for an uplink transmission resource and a set of measurement resources overlapping in time with the uplink transmission resource; and receive, from the UE, a CSI report including one or more CSI metrics, where the one or more CSI metrics are based on an SI measurement based on one or more uplink transmission power hypotheses, where the one or more uplink transmission power hypotheses for the SI measurement respectively correspond to the set of measurement resources. The component 199 may be further configured to perform any of the aspects described in connection with the flowchart in FIG. 18, and/or performed by the base station 1504 in FIG. 15. The component 199 may be within one or more processors (or processing circuitry) of one or more of the CU 2010, DU 2030, and the RU 2040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2002 may include a variety of components configured for various functions. In one configuration, the network entity 2002 includes means for transmitting, to a UE, a configuration for an uplink transmission resource and a set of measurement resources overlapping in time with the uplink transmission resource; and means for receiving, from the UE, a CSI report including one or more CSI metrics, where the one or more CSI metrics are based on an SI measurement based on one or more uplink transmission power hypotheses, where the one or more uplink transmission power hypotheses for the SI measurement respectively correspond to the set of measurement resources. The network entity 2002 may further include means for performing any of the aspects described in connection with the flowchart in FIG. 18, and/or aspects performed by the base station 1504 in FIG. 15. The means may be the component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a configuration for an uplink transmission resource and a set of measurement resources overlapping in time with the uplink transmission resource; performing an SI measurement based on one or more uplink transmission power hypotheses for the SI measurement, where the one or more uplink transmission power hypotheses for the SI measurement respectively correspond to the set of measurement resources; and transmitting, to the network entity, a CSI report including one or more CSI metrics based on the SI measurement. By incorporating the impact of SI into CSI metrics, the methods enable more accurate and efficient CSI reporting for SBFD capable UE. Additionally, by enhancing CSI reporting to account for the impact of SI under multiple uplink transmit power hypotheses, the methods enable the network to better adapt to varying SI conditions at the UE, thereby allowing for more accurate scheduling and resource allocation.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE). The method includes receiving, from a network entity, a configuration for an uplink transmission resource and a set of measurement resources overlapping in time with the uplink transmission resource; performing a self-interference (SI) measurement based on one or more uplink transmission power hypotheses for the SI measurement, wherein the one or more uplink transmission power hypotheses for the SI measurement respectively correspond to the set of measurement resources; and transmitting, to the network entity, a channel state information (CSI) report comprising one or more CSI metrics based on the SI measurement.

Aspect 2 is the method of aspect 1, wherein the method further includes transmitting an uplink signal using the uplink transmission resource, wherein an uplink power for the uplink signal is based on a power control configuration from the network entity.

Aspect 3 is the method of aspect 2, wherein the method further includes determining, based on a power control state for the SI measurement, the one or more uplink transmission power hypotheses for the SI measurement, wherein the one or more uplink transmission power hypotheses are independent from the uplink power.

Aspect 4 is the method of aspect 3, wherein determining the one or more uplink transmission power hypotheses for the SI measurement comprises determining, based on a defined rule, the one or more uplink transmission power hypotheses for the SI measurement.

Aspect 5 is the method of any of aspects 1 to 2, wherein the one or more uplink transmission power hypotheses include multiple uplink transmission power hypotheses, the method further comprising receiving, from the network entity, a CSI report configuration for the CSI report or a semi-persistent or periodic (SP/P) uplink transmission configuration for the uplink signal, wherein the CSI report configuration or the SP/P uplink transmission configuration indicates the multiple uplink transmission power hypotheses.

Aspect 6 is the method of aspect 5, wherein the uplink signal includes a sounding reference signal (SRS) with repetition, wherein transmitting the uplink signal comprises transmitting multiple symbols associated with the uplink signal respectively using the multiple uplink transmission power hypotheses.

Aspect 7 is the method of any of aspects 1 to 6, wherein the one or more uplink transmission power hypotheses include multiple uplink transmission power hypotheses, and wherein the CSI report includes multiple CSI metrics respectively corresponding to the multiple uplink transmission power hypotheses.

Aspect 8 is the method of aspect 7, wherein the method further includes receiving multiple CSI report sub-configurations, wherein each CSI report sub-configuration of the multiple CSI report sub-configurations corresponds to one uplink transmission power hypothesis of the multiple uplink transmission power hypotheses.

Aspect 9 is the method of aspect 8, wherein the multiple CSI report sub-configurations correspond to a channel measurement resource (CMR), and the multiple CSI report sub-configurations correspond to different interference measurement resources (IMR).

Aspect 10 is the method of aspect 7, wherein each uplink transmission power hypothesis of the multiple uplink transmission power hypotheses corresponds to a trigger event corresponding to triggering the CSI report.

Aspect 11 is the method of any of aspects 1 to 10, wherein the one or more uplink transmission power hypotheses include multiple uplink transmission power hypotheses, wherein the CSI report includes one CSI metric based on one uplink transmission power hypothesis of the multiple uplink transmission power hypotheses.

Aspect 12 is the method of aspect 11, wherein the CSI report includes a power indicator for the one uplink transmission power hypothesis of the multiple uplink transmission power hypotheses corresponding to the one CSI metric.

Aspect 13 is the method of aspect 11, wherein the method further includes selecting, based on a selection criterion, the one uplink transmission power hypothesis corresponding to the CSI metric from the multiple uplink transmission power hypotheses.

Aspect 14 is the method of aspect 13, wherein the selection criterion is based on one or more of: a threshold reduction in a receiver sensitivity; a modulation and coding scheme (MCS) degradation threshold; or an implementation on the UE.

Aspect 15 is the method of any of aspects 1 to 14, wherein an inclusion of the one or more CSI metrics based on the SI measurement in the CSI report is based on a CSI report configuration or a self-interference measurement resource (SIMR) associated with the CSI report.

Aspect 16 is the method of any of aspects 1 to 14, wherein each measurement resource of the set of measurement resources corresponds to one CSI-RS resource of one or more CSI-RS resources for a channel measurement, wherein the one or more uplink transmission power hypotheses correspond to: one or more symbols in one measurement occasion in the set of measurement resources; or one or more measurement occasions in one measurement resource of the set of measurement resources.

Aspect 17 is the method of any of aspects 1 to 14, wherein the set of measurement resources is located in a resource set, and wherein a CSI-RS channel measurement resource corresponds to the set of measurement resources.

Aspect 18 is the method of any of aspects 1 to 14, wherein each measurement resource of the set of measurement resources is associated with all channel measurement resources of the UE.

Aspect 19 is the method of any of aspects 1 to 14, wherein the set of measurement resources is based on channel measurement resources of the UE.

Aspect 20 is the method of any of aspects 1 to 19, wherein the CSI report includes an interference indication bit indicative of an inclusion or an absence of the SI measurement in the CSI report.

Aspect 21 is the method of any of aspects 1 to 20, wherein the method further includes computing CSI for the CSI report using all measurement occasions associated with the set of measurement resources.

Aspect 22 is the method of any of aspects 1 to 20, wherein the method further includes computing CSI for the CSI report using one or more measurement occasions associated with the set of measurement resources, wherein the one or more measurement occasions are associated with an SI interference.

Aspect 23 is an apparatus for wireless communication at a UE, comprising: at least one memory; and at least one processor coupled to the at least one memory, the at least one processor is configured to perform the method of any of aspects 1 to 22.

Aspect 24 is the apparatus for wireless communication at a UE, comprising means for performing each step in the method of any of aspects 1-22.

Aspect 25 is an apparatus of any of aspects 23-24, further comprising a transceiver configured to receive or to transmit in association with the method of any of aspects 1-22.

Aspect 26 is a computer-readable medium (e.g., a non-transitory computer-readable medium) storing computer executable code at a UE, the code when executed by at least one processor causes the at least one processor to perform the method of any of aspects 1-22.

Aspect 27 is a method of wireless communication at a network entity. The method includes transmitting, to a user equipment (UE), a configuration for an uplink transmission resource and a set of measurement resources overlapping in time with the uplink transmission resource; and receiving, from the UE, a channel state information (CSI) report comprising one or more CSI metrics, wherein the one or more CSI metrics are based on a self-interference (SI) measurement based on one or more uplink transmission power hypotheses, wherein the one or more uplink transmission power hypotheses for the SI measurement respectively correspond to the set of measurement resources.

Aspect 28 is the method of aspect 27, where the method further includes receiving, from the UE, an uplink signal using the uplink transmission resource, wherein an uplink power for the uplink signal is based on a power control configuration from the network entity.

Aspect 29 is an apparatus for wireless communication at a network entity, comprising: at least one memory; and at least one processor coupled to the at least one memory and, where the at least one processor is configured to perform the method of any of aspects 27-28.

Aspect 30 is the apparatus for wireless communication at a network entity, comprising means for performing each step in the method of any of aspects 27-28.

Aspect 31 is an apparatus of any of aspects 29-30, further comprising a transceiver configured to receive or to transmit in association with the method of any of aspects 27-28.

Aspect 32 is a computer-readable medium (e.g., a non-transitory computer-readable medium) storing computer executable code at a network entity, the code when executed by at least one processor causes the at least one processor to perform the method of any of aspects 27-28.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network entity, a configuration for an uplink transmission resource and a set of measurement resources overlapping in time with the uplink transmission resource;
perform a self-interference (SI) measurement based on one or more uplink transmission power hypotheses for the SI measurement, wherein the one or more uplink transmission power hypotheses for the SI measurement respectively correspond to the set of measurement resources; and
transmit, to the network entity, a channel state information (CSI) report comprising one or more CSI metrics based on the SI measurement.

2. The apparatus of claim 1, further comprising a transceiver coupled to the at least one processor, wherein to transmit the CSI report, the at least one processor is configured to transmit the CSI report via the transceiver, and wherein the at least one processor is further configured to:
transmit an uplink signal using the uplink transmission resource, wherein an uplink power for the uplink signal is based on a power control configuration from the network entity.

3. The apparatus of claim 2, wherein the at least one processor is further configured to:
determine, based on a power control state for the SI measurement, the one or more uplink transmission power hypotheses for the SI measurement, wherein the one or more uplink transmission power hypotheses are independent from the uplink power.

4. The apparatus of claim 3, wherein to determine the one or more uplink transmission power hypotheses for the SI measurement, the at least one processor is configured to:
determine, based on a defined rule, the one or more uplink transmission power hypotheses for the SI measurement.

5. The apparatus of claim 2, wherein the one or more uplink transmission power hypotheses include multiple uplink transmission power hypotheses, and wherein the at least one processor is further configured to:
receive, from the network entity, a CSI report configuration for the CSI report or a semi-persistent or periodic (SP/P) uplink transmission configuration for the uplink signal, wherein the CSI report configuration or the SP/P uplink transmission configuration indicates the multiple uplink transmission power hypotheses.

6. The apparatus of claim 5, wherein the uplink signal includes a sounding reference signal (SRS) with repetition, wherein to transmit the uplink signal, the at least one processor is configured to:
transmit multiple symbols associated with the uplink signal respectively using the multiple uplink transmission power hypotheses.

7. The apparatus of claim 1, wherein the one or more uplink transmission power hypotheses include multiple uplink transmission power hypotheses, and wherein the CSI report includes multiple CSI metrics respectively corresponding to the multiple uplink transmission power hypotheses.

8. The apparatus of claim 7, wherein the at least one processor is further configured to:
receive multiple CSI report sub-configurations, wherein each CSI report sub-configuration of the multiple CSI report sub-configurations corresponds to one uplink transmission power hypothesis of the multiple uplink transmission power hypotheses.

9. The apparatus of claim 8, wherein the multiple CSI report sub-configurations correspond to a channel measurement resource (CMR), and the multiple CSI report sub-configurations correspond to different interference measurement resources (IMR).

10. The apparatus of claim 7, wherein each uplink transmission power hypothesis of the multiple uplink transmission power hypotheses corresponds to a trigger event corresponding to triggering the CSI report.

11. The apparatus of claim 1, wherein the one or more uplink transmission power hypotheses include multiple uplink transmission power hypotheses, wherein the CSI report includes one CSI metric based on one uplink transmission power hypothesis of the multiple uplink transmission power hypotheses.

12. The apparatus of claim 11, wherein the CSI report includes a power indicator for the one uplink transmission power hypothesis of the multiple uplink transmission power hypotheses corresponding to the one CSI metric.

13. The apparatus of claim 11, wherein the at least one processor is further configured to:
select, based on a selection criterion, the one uplink transmission power hypothesis corresponding to the CSI metric from the multiple uplink transmission power hypotheses.

14. The apparatus of claim 13, wherein the selection criterion is based on one or more of:
a threshold reduction in a receiver sensitivity,
a modulation and coding scheme (MCS) degradation threshold, or
an implementation on the UE.

15. The apparatus of claim 1, wherein an inclusion of the one or more CSI metrics based on the SI measurement in the CSI report is based on a CSI report configuration or a self-interference measurement resource (SIMR) associated with the CSI report.

16. The apparatus of claim 1, wherein each measurement resource of the set of measurement resources corresponds to one CSI-RS resource of one or more CSI-RS resources for a channel measurement, wherein the one or more uplink transmission power hypotheses correspond to:
one or more symbols in one measurement occasion in the set of measurement resources, or
one or more measurement occasions in one measurement resource of the set of measurement resources.

17. The apparatus of claim 1, wherein the set of measurement resources is located in a resource set, and wherein a CSI-RS channel measurement resource corresponds to the set of measurement resources.

18. The apparatus of claim 1, wherein each measurement resource of the set of measurement resources is associated with all channel measurement resources of the UE.

19. A method of wireless communication at a user equipment (UE), comprising:
receiving, from a network entity, a configuration for an uplink transmission resource and a set of measurement resources overlapping in time with the uplink transmission resource;
performing a self-interference (SI) measurement based on one or more uplink transmission power hypotheses for the SI measurement, wherein the one or more uplink transmission power hypotheses for the SI measurement respectively correspond to the set of measurement resources; and
transmitting, to the network entity, a channel state information (CSI) report comprising one or more CSI metrics based on the SI measurement.

20. An apparatus for wireless communication at a network entity, comprising:
at least one memory; and
at least one processor coupled to the at least one memory and, based at least in part on information stored in the at least one memory, the at least one processor is configured to:
transmit, to a user equipment (UE), a configuration for an uplink transmission resource and a set of measurement resources overlapping in time with the uplink transmission resource; and
receive, from the UE, a channel state information (CSI) report comprising one or more CSI metrics, wherein the one or more CSI metrics are based on a self-interference (SI) measurement based on one or more uplink transmission power hypotheses, wherein the one or more uplink transmission power hypotheses for the SI measurement respectively correspond to the set of measurement resources.
